(19) United States
(12) Patent Application Publication
(10) Pub. No.: US 2012/0071032 A1
(43) Pub. Date: Mar. 22, 2012

(54) ELECTRICAL RECEPTACLE

(76) Inventor: Chou-Hsien TSAI, New Taipei City (TW)

(21) Appl. No.: 13/234,300

(22) Filed: Sep. 16, 2011

(30) Foreign Application Priority Data
Sep. 17, 2010 (TW) 099218168
Sep. 21, 2010 (TW) 099132112
Jan. 14, 2011 (TW) 100101403
Jan. 21, 2011 (TW) 100102262

(51) Int. Cl. H01R 24/28

(52) U.S. Cl. 439/660

(57) ABSTRACT

An electrical receptacle includes a plastic main body, a plastic tongue plate, and a circuit board. The plastic main body has a first docking space and a second docking space. The plastic tongue plate has a first surface, a second surface, and a plurality of slots. The slots run through the first surface and the second surface of the plastic tongue plate. The circuit board has a first surface, a second surface, and a plurality of grooves. The grooves run through the first surface and the second surface of the circuit board. The circuit board is accommodated within the second surface of the plastic tongue plate. Moreover, the first surface of the circuit board is arranged beside the second surface of the plastic tongue plate.

### FIELD OF THE INVENTION

The present invention relates to an electrical receptacle, and more particularly to an electrical receptacle with a single type of signal interface or various types of signal interfaces and with a novel receptacle structure.

### BACKGROUND OF THE INVENTION

Nowadays, the functions of various electronic products become more powerful. Since handheld devices are increasingly popular, the demands on the data transmission between various electronic products or handheld devices are increased. As the volume of the electronic product or the handheld device is gradually reduced, there is a need of installing more connecting interfaces (e.g. electrical receptacles) on the casing's peripheral profile (also referred as a casing's coastline) of the electronic product or the handheld device so as to exchange signals between different devices.

For example, in accordance with a widely-used method, various signal interfaces may be integrated into a single electrical receptacle in order to give the users more choices about the signal interfaces. Since the transmission speed of the universal serial bus 2.0 (also referred as USB 2.0) interface is unsatisfied, the trend of using the shared single electrical receptacle become more popular. For example, the signal interfaces of the single electrical receptacle may comply with the external Serial ATA (also referred as eSATA) signal interface protocol, the universal serial bus 3.0 (also referred as USB 3.0) signal interface protocol, or the like.

Consequently, there is a need of providing an electrical receptacle with various signal interfaces for allowing an electrical plug with various signal interfaces to be coupled therewith. Especially, as the transmission speed of the data transmission signal interface or the image transmission signal interface is gradually increased, the adverse influence of the crosstalk or electromagnetic interference on the interface signals during operations of the signal interfaces should be reduced. Moreover, for complying with various size specifications of the electronic products or the handheld devices, there is a need of providing an electrical receptacle with reduced assembling complexity and reduced fabricating cost.

One the other hand, the electrical receptacle complying with a single data transmission protocol (e.g. USB 2.0 or USB 3.0) for transmitting signals in a unidirectional or bidirectional conducting manner or the electrical receptacle complying with various data transmission protocols (e.g. USB 2.0 or USB 3.0 and eSATA) should be further improved. That is, there is a need of providing an electrical receptacle with an improved receptacle structure.

### SUMMARY OF THE INVENTION

The present invention provides an electrical receptacle having a shared docking recess for accommodating an electrical plug with various signal interfaces.

The present invention further provides an electrical receptacle for simultaneously receiving the signal interface units of various signal interfaces.

The present invention further provides an electrical receptacle for minimizing the adverse influence of the crosstalk or electromagnetic interference on the interface signals during operations of various high-speed data transmission signal interfaces or high-speed image transmission signal interfaces.

The present invention further provides an electrical receptacle with reduced assembling complexity and reduced fabricating cost.

The present invention further provides an electrical receptacle with a novel receptacle structure.

In accordance with a first aspect of the present invention, there is provided an electrical receptacle having at least one docking space for accommodating an electrical plug. The electrical receptacle includes a plastic main body, a tongue plate, and a circuit board. The tongue plate has a first tongue plate surface and a second tongue plate surface. The circuit board is accommodated within a receiving space of the tongue plate, and has a first circuit board surface and a second circuit board surface. Moreover, a first signal interface is installed on the circuit board.

In an embodiment, the electrical receptacle further includes a rear cover. The rear cover includes a plurality of fixing recesses with position-limiting structures for previously accommodating and fixing at least a portion of extension segments or fixture segments of an additional signal interface. Alternatively, wherein the rear cover has a plurality of receiving holes for accommodating at least a portion of pin segments of the first signal interface and the additional signal interface. Alternatively, the rear cover includes a plurality of fixing recesses for previously accommodating and fixing at least a portion of extension segments or fixture segments of the additional signal interface, and a plurality of receiving holes for accommodating at least a portion of pin segments of the first signal interface and the additional signal interface.

In an embodiment, the electrical receptacle further includes a pressing plate or a pressing structure, which is either an individual component or a part of the rear cover.

In an embodiment, the electrical receptacle further includes a second signal interface and/or a third signal interface. At least one of the second signal interface and the third signal interface is installed on the plastic main body, or installed on the circuit board, or installed in a second docking space beside the circuit board, or installed on the tongue plate, or installed in a first docking space beside the tongue plate, or installed in a region between the tongue plate and the circuit board, or installed on the rear cover, or installed in the at least one docking space including at least one of the first docking space and the second docking space.

In an embodiment, no signal interface is installed on the plastic main body, or the plastic main body has two lateral walls extended toward a front side thereof, or the plastic main body is not integrally formed with the tongue plate. Moreover, a shared profile mating with various signal interfaces of the electrical plug is defined by front peripheries of the two lateral walls.

In an embodiment, the tongue plate is a plastic tongue plate fixed on a sidewall of a bottom part of the plastic main body and extended toward a front side thereof, or the tongue plate is a removable plastic tongue plate assembled with the plastic main body. Moreover, the circuit board is a removable circuit board.

In an embodiment, the plastic tongue plate and the plastic main body are combined together in an up/down stacking manner.

In an embodiment, the plastic tongue plate is an individual component, or the plastic tongue plate and the rear cover are integrally formed.

In an embodiment, the plastic tongue plate has a plurality of slots running through the first tongue plate surface and the second tongue plate surface, and the circuit board has a plurality of grooves running through the first circuit board surface and the second circuit board surface, wherein the slots of the plastic tongue plate and the grooves of the circuit board are aligned with each other, so that the first docking space and the second docking space are in communication with each other.

In an embodiment, the second signal interface has a plurality of contact resilience arm segments penetrated through the slots of the plastic tongue plate and the grooves of the circuit board, so that the contact resilience arm segments are accommodated within the first docking space. In addition, the second signal interface has a plurality of extension segments or extension wires and a plurality of pin segments, which are accommodated within the second docking space.

In an embodiment, the electrical receptacle further includes a beveled edge structure, which is located at a front end of the plastic tongue plate and a front end of the circuit board for facilitating the electrical plug to be accommodated within at least one of the first docking space and the second docking space. The beveled edge structure is coupled with the front end of the plastic tongue plate. The beveled edge structure has a vertical bulge for blocking the front end and a part of a lateral edge of the circuit board. Alternatively, the vertical bulge of the beveled edge structure is integrally extended from the front end of the plastic tongue plate for blocking the front end and the part of the lateral edge of the circuit board.

In an embodiment, the first signal interface is an eSATA signal interface, the second signal interface is a USB 2.0 signal interface, and the third signal interface and the USB 2.0 signal interface are collaboratively defined as a USB3.0 signal interface. Each signal interface unit of the first signal interface, the second signal interface and the third signal interface is composed of four structure segments: (1) a contact pad or a contact resilience arm segment or a contact segment, (2) an extension wire or an extension segment, (3) a fixture segment, and (4) a pin segment or a welding segment, or each signal interface unit of the first signal interface, the second signal interface and the third signal interface is composed of three structure segments: (1) a contact pad or a contact resilience arm segment or a contact segment, (2) an extension wire or an extension segment, and (3) a pin segment or a welding segment, or each signal interface unit of the first signal interface, the second signal interface and the third signal interface is composed of two structure segments: (1) a contact and extension segment or a contact and extension wire, and (2) a pin segment or a welding segment.

In an embodiment, the first docking space is a lateral space beside the first tongue plate surface and excluding the first tongue plate surface, and the second docking space is another lateral space beside the second circuit board surface and excluding the second circuit board surface.

In an embodiment, the receiving space is arranged beside the second tongue plate surface for accommodating the circuit board, wherein the first circuit board surface is arranged beside the second tongue plate surface.

In an embodiment, the receiving space is defined by the second tongue plate surface and a vertical bulge of the tongue plate. Alternatively, the receiving space is defined by the second tongue plate surface, a bottom part of the plastic main body or a sidewall of the rear cover, and the vertical bulge. When the circuit board is accommodated within the receiving space, an altitude of the second circuit board surface is identical to or different from an altitude of a surface of the vertical bulge.

In an embodiment, the receiving space is located within the tongue plate and arranged between the first tongue plate surface and the second tongue plate surface for accommodating the circuit board.

In an embodiment, the electrical receptacle further includes a metallic casing. The metallic casing is sheathed around the plastic main body, or the metallic casing is sheathed around an outer periphery of a combination of the plastic main body and a rear cover.

In accordance with a second aspect of the present invention, there is provided an electrical receptacle having at least one docking space for accommodating an electrical plug. The electrical receptacle includes a first plastic main body, a plastic tongue plate, a circuit board, a second plastic main body, and a plurality of signal interfaces. The plastic tongue plate is installed on the first plastic main body, and has a first tongue plate surface and a second tongue plate surface. The circuit board is accommodated within a receiving space of the tongue plate, and has a first circuit board surface and a second circuit board surface. The second plastic main body is combined with or integrally with at least one of the first plastic main body and the plastic tongue plate. At least one signal interface is installed on the circuit board. In addition, the other ones of the signal interfaces are installed on at least one of the first plastic main body, the plastic tongue plate and the second plastic main body.

In accordance with a third aspect of the present invention, there is provided an electrical receptacle having at least one docking space for accommodating an electrical plug. The electrical receptacle includes a plurality of signal interfaces and a composite tongue plate structure. The composite tongue plate structure is coupled with the electrical plug. In addition, at least one of a top surface and a bottom surface of the composite tongue plate structure is arranged beside the at least one docking space including at least one of the first docking space and a second docking space. Moreover, the composite tongue plate structure is composed of a plastic tongue plate and a circuit board.

In an embodiment, the plurality of signal interfaces include a USB2.0 or USB3.0 signal interface and an eSATA signal interface, which are collaboratively defined as an all-in-one signal interface, or the plurality of signal interfaces include two USB2.0 signal interfaces or two USB3.0 signal interfaces, or the plurality of signal interfaces are collaboratively defined as a high-speed transmission signal interface including a single-type eSATA signal interface or a single-type USB3.0 signal interface. Each signal interface unit of the signal interfaces is composed of four structure segments: (1) a contact pad or a contact resilience arm segment or a contact segment, (2) an extension wire or an extension segment, (3) a fixture segment, and (4) a pin segment or a welding segment, or each signal interface unit of the signal interfaces is composed of three structure segments: (1) a contact pad or a contact resilience arm segment or a contact segment, (2) an extension wire or an extension segment, and (3) a pin segment or a welding segment, or each signal interface unit of the signal interfaces is composed of two structure segments: (1) a contact and extension segment or a contact and extension wire, and (2) a pin segment or a welding segment.

In accordance with a fourth aspect of the present invention, there is provided an electrical receptacle having at least one docking space for accommodating an electrical plug. The electrical receptacle includes a plurality of signal interfaces and a composite tongue plate structure. The composite tongue plate structure is coupled with the electrical plug. A metallic contact part of at least one signal interface is installed on each of a top surface and a bottom surface of the composite tongue plate structure. Moreover, the composite tongue plate structure is composed of a plastic tongue plate and a circuit board.

In an embodiment, the plurality of signal interfaces include a USB2.0 or USB3.0 signal interface and an eSATA signal interface, which are collaboratively defined as an all-in-one signal interface. Alternatively, the signal interfaces include two USB2.0 signal interfaces or two USB3.0 signal interfaces. Alternatively, the signal interfaces are collaboratively defined as a high-speed transmission signal interface including a single-type eSATA signal interface or a single-type USB3.0 signal interface. Moreover, each signal interface unit of the signal interfaces is composed of four structure segments: (1) a contact pad or a contact resilience arm segment or a contact segment, (2) an extension wire or an extension segment, (3) a fixture segment, and (4) a pin segment or a welding segment, or each signal interface unit of the signal interfaces is composed of three structure segments: (1) a contact pad or a contact resilience arm segment or a contact segment, (2) an extension wire or an extension segment, and (3) a pin segment or a welding segment, or each signal interface unit of the signal interfaces is composed of two structure segments: (1) a contact and extension segment or a contact and extension wire, and (2) a pin segment or a welding segment.

In accordance with a fifth aspect of the present invention, there is provided an electrical receptacle having at least one docking space for accommodating an electrical plug. The electrical receptacle includes a first plastic main body, a plastic tongue plate, a circuit board, and a plurality of signal interface structure segments. The plastic tongue plate is installed on the first plastic main body, and has a first tongue plate surface and a second tongue plate surface. The circuit board is accommodated within a receiving space of the tongue plate, and has a first circuit board surface and a second circuit board surface. Moreover, at least a portion of the signal interface structure segments are installed on the circuit board. The other ones of the signal interface structure segments are installed on at least one of the first plastic main body and the plastic tongue plate.

In an embodiment, the plurality of signal interface structure segments include USB2.0 or USB3.0 signal interface structure segments and eSATA signal interface structure segments to be collaboratively defined as an all-in-one signal interface. Alternatively, the plurality of signal interface structure segments include two groups of USB2.0 signal interface structure segments or two groups of USB3.0 signal interface structure segments to be collectively defined as two USB2.0 signal interfaces or two USB3.0 signal interfaces. Alternatively, the plurality of signal interface structure segments are high-speed transmission signal interface structure segments including single-type eSATA signal interface structure segments or single-type USB3.0 signal interface structure segments to be collaboratively defined as a high-speed transmission signal interface including a single-type eSATA signal interface or a single-type USB3.0 signal interface. Moreover, the signal interface structure segments are classified into four types: (1) a contact pad or a contact resilience arm segment or a contact segment, (2) an extension wire or an extension segment, (3) a fixture segment, and (4) a pin segment or a welding segment, or the signal interface structure segments are classified into three types: (1) a contact pad or a contact resilience arm segment or a contact segment, (2) an extension wire or an extension segment, and (3) a pin segment or a welding segment, or the signal interface structure segments are classified into two types: (1) a contact and extension segment or a contact and extension wire, and (2) a pin segment or a welding segment.

In an embodiment, the receiving space is disposed within the plastic tongue plate and arranged between the first tongue plate surface and the second tongue plate surface for accommodating the circuit board. A plurality of contact holes are located at a front end of at least one of the first tongue plate surface and the second tongue plate surface for at least partially accommodating the contact segments or the contact and extension segments. The contact holes are in communication with the receiving space and at least one of the first circuit board surface and the second circuit board surface.

In an embodiment, the at least a portion of the signal interface structure segments installed on the circuit board are elastically sustained against or fixedly welded on another portion of the signal interface structure segments so as to be electrically connected with each other.

In an embodiment, the USB3.0 signal interface has five first signal interface units with the contact segments, and the each of the five first signal interface units successively comprises three structure segments: (1) the contact segment, (2) the extension wire, and (3) the pin segment or the welding segment. Each signal interface unit of the eSATA signal interface successively comprises three structure segments: (1) the contact pad, (2) the extension wire, and (3) the pin segment or the welding segment. The extension wire is formed on the circuit board, and a first conductive pad and a second conductive pad are respectively disposed at a front end and a rear end of the extension wire, so that the contact segment is elastically sustained against or fixedly welded on the first conductive pad and/or the pin segment or the welding segment is elastically sustained against or fixedly welded on the second conductive pad.

In an embodiment, the USB3.0 signal interface further has four second signal interface units with the contact resilience arm segments, and the pin segments or the welding segments of the five first signal interface units and the pin segments or the welding segments of the four second signal interface units are arranged in parallel with each other or arranged in a staggered form. The pin segments or welding segments of two of the four second signal interface units are located near a middle position of the electrical receptacle for transmitting a first signal group. The pin segments or the welding segments of the other two of the four second signal interface units are arranged at bilateral sides of the pin segments or the welding segments of the two signal interface units which transmit the first signal group. Alternatively, the extension wire or the welding segment or the welding segment of one of the five first signal interface units is arranged near the middle position of the electrical receptacle to be used as a ground signal interface unit for transmitting a ground signal. The extension wires or the welding segments or the welding segments of two of the other four first signal interface units are arranged at each of bilateral sides of the ground signal interface unit for transmitting a second signal group. Alternatively, the pin segments or the welding segments of the two second signal interface units for transmitting the first signal group are closer to the pin segment or the welding segment of the ground signal interface unit than the pin segments or the welding segments of the four second signal interface units for transmitting the second signal group.

In an embodiment, the plastic tongue plate includes a plurality of position-limiting recesses not running through the first tongue plate surface and the second tongue plate surface. The contact resilience arm segments exposed to the at least one docking space are sustained against corresponding position-limiting recesses. The position-limiting recesses are formed in one of the first tongue plate surface and the second tongue plate surface and exposed to the at least one docking space, but are not in communication with the receiving space.

In an embodiment, the plastic tongue plate has a plurality of slots running through the first tongue plate surface and the second tongue plate surface, wherein corresponding contact resilience arm segments are penetrated through the slots of the plastic tongue plate and exposed to the at least one docking space.

In an embodiment, the electrical receptacle further includes a second plastic main body. The second plastic main body is combined with or integrally formed with at least one of the first plastic main body and the plastic tongue plate. The other ones of the signal interface structure segments are installed on at least one of the first plastic main body, the second plastic main body and the plastic tongue plate.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a top side and a front side of an electrical receptacle according to a first embodiment of the present invention;

FIG. 2 is a schematic three-dimensional view illustrating the electrical receptacle of the first embodiment and taken along different viewpoints;

FIG. 3 is a schematic partial exploded view illustrating the electrical receptacle of the first embodiment;

FIG. 4 is a schematic partial exploded view illustrating the electrical receptacle of the first embodiment and taken along another viewpoint;

FIG. 5 is a schematic side view illustrating the connection between an electrical plug and the electrical receptacle of the first embodiment;

FIG. 6 is a schematic view illustrating a top side and a front side of an electrical receptacle according to a second embodiment of the present invention;

FIG. 7 is a schematic three-dimensional view illustrating the electrical receptacle of the second embodiment and taken along different viewpoints;

FIG. 8 is a schematic partial exploded view illustrating the electrical receptacle of the second embodiment;

FIG. 9 is a schematic partial exploded view illustrating the electrical receptacle of the second embodiment and taken along another viewpoint;

FIG. 10 is a schematic side view illustrating the connection between an electrical plug and the electrical receptacle of the second embodiment;

FIG. 11 is a schematic side view illustrating an electrical receptacle according to a third embodiment of the present invention;

FIG. 12 is a schematic side view illustrating an electrical receptacle according to a fourth embodiment of the present invention;

FIG. 13 is a schematic side view illustrating an electrical receptacle according to a fifth embodiment of the present invention;

FIG. 14 is a schematic side view illustrating an electrical receptacle according to a sixth embodiment of the present invention;

FIG. 15 is a schematic partial exploded view illustrating an electrical receptacle according to a seventh embodiment of the present invention;

FIG. 16 is a schematic partial exploded view illustrating the electrical receptacle of the seventh embodiment and taken along another viewpoint;

FIG. 17 is a schematic partial exploded view illustrating an electrical receptacle according to an eighth embodiment of the present invention;

FIG. 18 is a schematic partial exploded view illustrating the electrical receptacle of the eighth embodiment and taken along another viewpoint;

FIG. 19 is a schematic side view illustrating an electrical receptacle according to a ninth embodiment of the present invention;

FIG. 20 is a schematic partial exploded view illustrating an electrical receptacle according to a tenth embodiment of the present invention;

FIG. 21 is a schematic side view illustrating the electrical receptacle of the tenth embodiment;

FIG. 22 is a schematic side view illustrating an electrical receptacle according to an eleventh embodiment of the present invention;

FIG. 23 is a schematic partial exploded view illustrating an electrical receptacle according to a twelfth embodiment of the present invention;

FIG. 24 is a schematic partial exploded view illustrating the electrical receptacle of the twelfth embodiment and taken along another viewpoint;

FIG. 25 is a schematic side view illustrating an electrical receptacle according to a thirteenth embodiment of the present invention;

FIG. 26 is a schematic side view illustrating an electrical receptacle according to a fourteenth embodiment of the present invention;

FIG. 27 is a schematic side view illustrating an electrical receptacle according to a fifteenth embodiment of the present invention;

FIG. 28 is a schematic side view illustrating an electrical receptacle according to a sixteenth embodiment of the present invention;

FIG. 29 is a schematic partial exploded view illustrating an electrical receptacle according to a seventeenth embodiment of the present invention;

FIG. 30 is a schematic partial exploded view illustrating the electrical receptacle of the seventeenth embodiment and taken along another viewpoint;

FIG. 31 is a schematic partial exploded view illustrating an electrical receptacle according to an eighteenth embodiment of the present invention;

FIG. 32 is a schematic partial exploded view illustrating the electrical receptacle of the eighteenth embodiment and taken along another viewpoint;

FIGS. 33A-33D are schematic side views illustrating the relationships between the tongue plate and the circuit board for various exemplary electrical receptacles of the present invention;

FIG. 34 is a schematic side view illustrating an electrical receptacle according to a nineteenth embodiment of the present invention;

FIG. 35 is a schematic side view illustrating an electrical receptacle according to a twentieth embodiment of the present invention;

FIG. 36 is a schematic bottom view illustrating the circuit board of the electrical receptacle of the twentieth embodiment;

FIG. 37 is a schematic exploded view illustrating the circuit board and the tongue plate of the electrical receptacle of the twentieth embodiment;

FIG. 38 is a schematic exploded view illustrating the circuit board and the tongue plate of the electrical receptacle of the twentieth embodiment and taken along another viewpoint;

FIG. 39 is a schematic side view illustrating an electrical receptacle according to a twenty-first embodiment of the present invention;

FIG. 40 is a schematic side view illustrating an electrical receptacle according to a twenty-second embodiment of the present invention;

FIG. 41 is a schematic side view illustrating an electrical receptacle according to a twenty-third embodiment of the present invention;

FIG. 42 is a schematic top view illustrating the circuit board of the electrical receptacle of the twenty-third embodiment;

FIG. 43 is a schematic three-dimensional rear view illustrating the electrical receptacle of the twenty-third embodiment;

FIG. 44 is a schematic three-dimensional rear view illustrating an electrical receptacle according to a twenty-fourth embodiment of the embodiment;

FIG. 45 schematically illustrates arrangement of the insertion holes of a system board corresponding to the pin segments (or welding segments) of the electrical receptacle of the twenty-fourth embodiment;

FIG. 46 is a schematic side view illustrating an electrical receptacle according to a twenty-fifth embodiment of the embodiment;

FIG. 47 is a schematic side view illustrating an electrical receptacle according to a twenty-sixth embodiment of the embodiment; and

FIG. 48 is a schematic side view illustrating an electrical receptacle according to a twenty-seventh embodiment of the embodiment.

### DETAILED DESCRIPTION OF THE PREFERRED EMBODIMENT

The present invention provides an electrical receptacle. The concepts of the present invention may be applied to an electrical receptacle with a single type of signal interface or an all-in-one signal interface. In addition, the concepts of the present invention may be applied to an electrical receptacle with a unidirectional or bidirectional conducting means. For example, the concepts of the present invention are at least applied to the electrical receptacle having a USB2.0 or USB3.0 signal interface and an eSATA signal interface to comply with an all-in-one signal interface protocol. Alternatively, the concepts of the present invention are at least applied to the electrical receptacle comprising a single type of signal interface (e.g. a USB2.0 or USB3.0 signal interface) with no foolproof profile and with a bidirectional conducting means. Alternatively, the concepts of the present invention are at least applied to the electrical receptacle comprising a single type of high-speed transmission signal interface (e.g. an eSATA signal interface or a USB3.0 signal interface) or any other high-speed data transmission signal interface or high-speed image transmission signal interface.

Moreover, numerous modifications and alterations of the electrical receptacle may be made while retaining the teachings of the invention. For example, the electrical receptacle may comprise four individual structural components: (1) a plastic body (also referred as a plastic main body) with an integral tongue plate, (2) a circuit board, (3) a rear cover (also referred as a covering member), and (4) a metallic casing. Alternatively, the electrical receptacle may comprise four individual structural components: (1) a plastic body (or a plastic main body), (2) a circuit board, (3) a rear cover (also referred as a covering member) with an integral tongue plate, and (4) a metallic casing. Alternatively, the electrical receptacle may comprise five individual structural components: (1) a plastic body (or a plastic main body), (2) a tongue plate, (3) a circuit board, (4) a rear cover (also referred as a covering member), and (5) a metallic casing. It is noted that the following descriptions of preferred embodiments of this invention are presented herein for purpose of illustration and description only.

The plastic main body may be considered as a first plastic main body. The rear cover (also referred as a covering member), or an individual pressing plate (or pressing structure), or an integral combination of the rear cover (also referred as a covering member) and a pressing plate (or pressing structure) may be considered as a second plastic main body.

Moreover, according to the practical requirements, the manufacturer may determine whether a signal interface is installed on the plastic main body or not, whether two lateral walls are respectively extended from left/right sides of the plastic main body or not, whether the plastic main body has a bottom part (base part) or not, or whether the plastic main body has a foolproof profile mating with different signal interfaces. Consequently, numerous modifications and alterations may be made while retaining the teachings of the invention.

Moreover, the plastic main body of the electrical receptacle of the present invention has two lateral walls, which are extended toward the front side. The two lateral walls and the sidewall of at least one of a bottom part of the plastic main body and the rear cover collectively define a docking recess. Moreover, the electrical receptacle has at least one docking space including a first receptacle or a second docking space. The docking space is at least defined by the plastic tongue plate and the circuit board within the docking recess and the plastic main body or the rear cover. Alternatively, the docking space is further defined by a metallic casing. It is to be noted that the following descriptions of preferred embodiments of this invention are presented herein for purpose of illustration and description only.

The entrance of the docking recess at least comprises a shared profile mating with various signal interfaces of a corresponding electrical plug. It is preferred that the shared profile is located at the front peripheries of the two lateral walls of the plastic main body.

Moreover, the tongue plate used in the electrical receptacle may be a plastic tongue plate. In views of the relationship between the tongue plate and the main body, the plastic tongue plate may be integrally formed with the plastic main body to be served as an extension structure (i.e. a fixed plate) of the plastic main body. Alternatively, the tongue plate is an individual component (e.g. a removable plastic tongue plate). Alternatively, the tongue plate and some other components may be combined as an individual component. It is to be noted that the following descriptions of preferred embodiments of this invention are presented herein for purpose of illustration and description only. Moreover, the circuit board used in the electrical receptacle of the present invention is a removable circuit board. Of course, the circuit board may be accommodated within a receiving space of the plastic tongue plate or the removable plastic tongue plate. Alternatively, according to the practical requirements, the circuit board is not accommodated within the receiving space.

Moreover, in the electrical receptacle of the present invention, a fixed plastic tongue plate or a removable plastic tongue plate and a circuit board may be collaboratively defined as a composite tongue plate structure.

Moreover, the signal interface unit of any signal interface used in the electrical receptacle of the present invention may comprise a single conductive terminal or further comprise a contact pad and an extension wire. According to the specifications of the general electric connector, the signal interface unit is composed of four structure segments: (1) a metallic contact part such as a (metallic) contact resilience arm segment or a (metallic) contact pad or a (metallic) contact segment, (2) a (metallic) extension segment (or an extension wire), (3) a (metallic) fixture segment, and (4) a metallic pin segment (a welding segment). Due to these four structure segments, the signal interface unit is effective to completely transmit an interface signal. Of course, these structure segments may have different definitions, explanations or classifications. For example, by changing the definition and classification, the signal interface unit may be composed of two structure segments: (1) a (metallic) contact and extension segment (contact and extension wire), and (2) a metallic pin segment (a welding segment). Alternatively, the signal interface unit may be composed of three structure segments: (1) a (metallic) contact resilience arm part (a contact pad or a contact segment), (2) a (metallic) extension segment (or an extension wire), and (3) a metallic pin segment (a welding segment). Of course, the structure segments may have different explanations or classifications, which are well known to those skilled in the art.

Hereinafter, any signal interface used in the electrical receptacle of the present invention will be illustrated by referring to a signal interface including three kinds of structure segments: (1) a metallic contact part such as a (metallic) contact resilience arm segment or a contact pad or a contact segment, (2) an extension segment (or an extension wire), and (3) a pin segment.

Moreover, the structural relationship or spatial arrangement between the signal interfaces or the structure segments of various signal interfaces and other components or structures (e.g. the plastic main body, the tongue plate, the circuit board or the rear cover) and the structural relationship or spatial arrangement between the above components or structures (e.g. the plastic main body, the tongue plate, the circuit board or the rear cover) may be varied according to the practical requirements or according to the fabricating process (e.g. a plastic insert molding process or a circuit board forming process). It is to be noted that the following descriptions of preferred embodiments of this invention are presented herein for purpose of illustration and description only.

Moreover, a metallic contact part of at least one signal interface is located at each of the top side and the bottom side of the single plastic tongue plate or the composite tongue plate structure of the electrical receptacle. Moreover, the two metallic contact parts on different positions of the top side and the bottom side of the plastic tongue plate are respectively exposed to or arranged beside different docking space. Alternatively, a metallic contact part of at least one signal interface is located at only the top side or the bottom side of the single plastic tongue plate or the composite tongue plate structure.

In the following descriptions of preferred embodiments and clams of this invention, the concepts or mechanisms of arranging the components or structures may be implements by various specified embodiments. The specified embodiment includes but is not limited to the combination assembly (also referred as a detachable combination assembly), the integrally-formed assembly or the secondary processing assembly (at least including fastening or welding means).

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

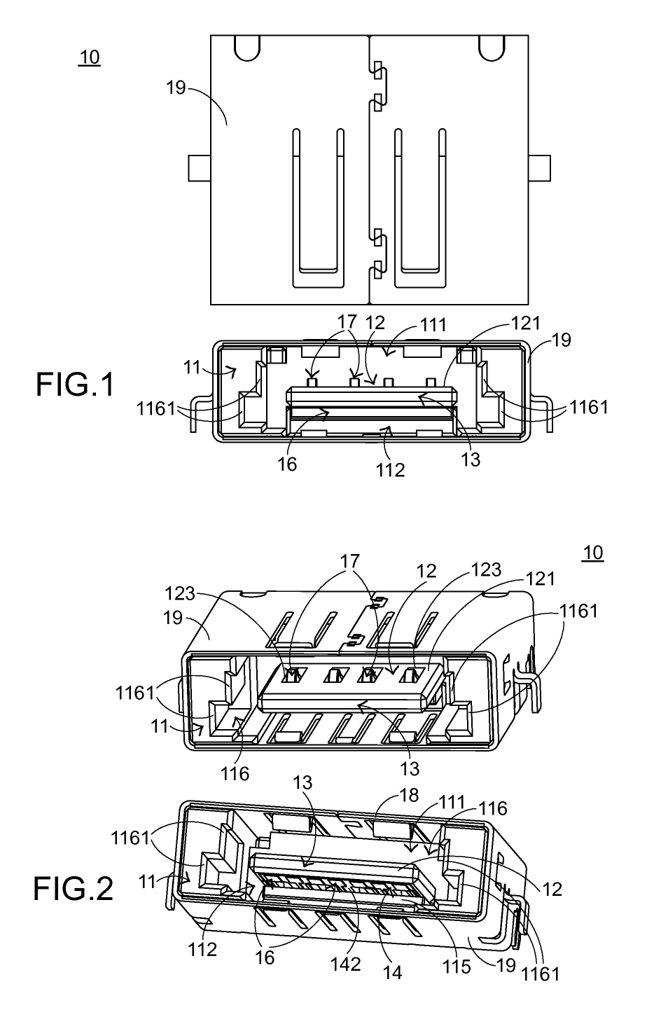

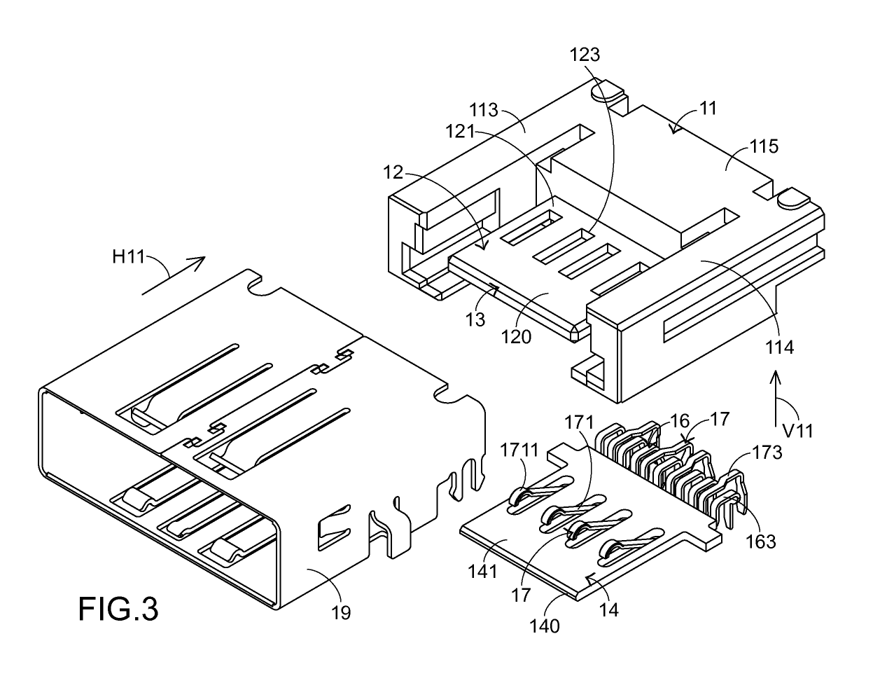

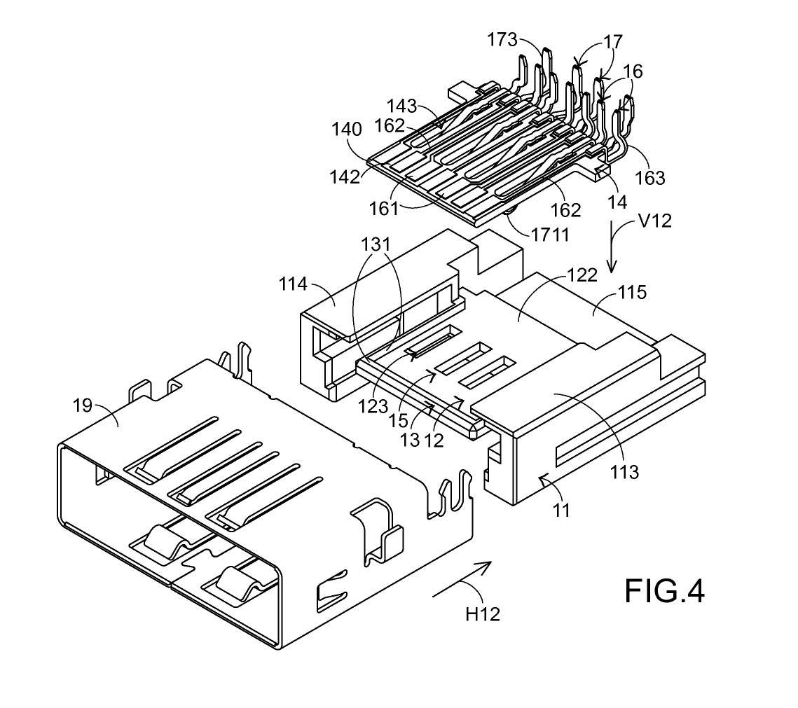

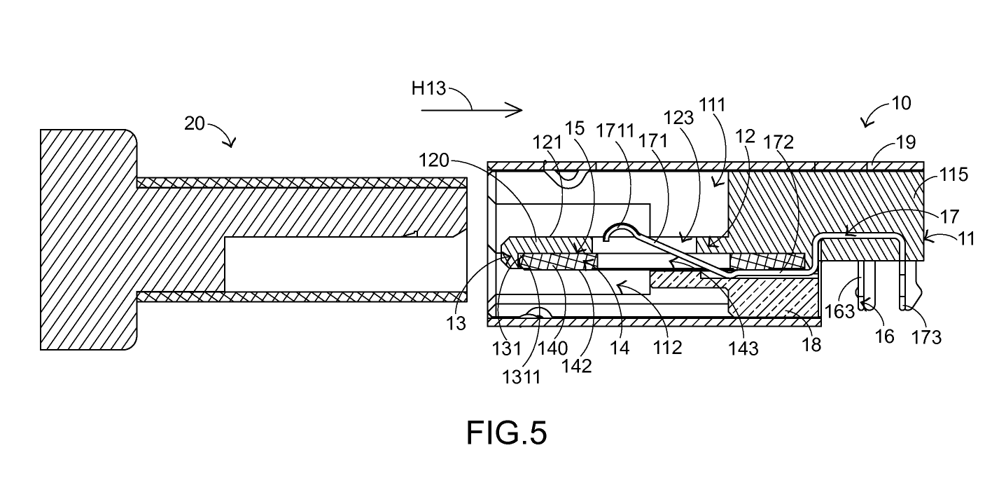

Please refer to FIGS. 1-5. FIG. 1 is a schematic view illustrating a top side and a front side of an electrical receptacle according to a first embodiment of the present invention. FIG. 2 is a schematic three-dimensional view illustrating the electrical receptacle of the first embodiment and taken along different viewpoints. FIG. 3 is a schematic partial exploded view illustrating the electrical receptacle of the first embodiment. FIG. 4 is a schematic partial exploded view illustrating the electrical receptacle of the first embodiment and taken along another viewpoint. FIG. 5 is a schematic side view illustrating the connection between an electrical plug and the electrical receptacle of the first embodiment.

As shown in FIGS. 1-5, the electrical receptacle 10 comprises a main body 11, a tongue plate 12, and a circuit board 14. The main body 11 has a first docking space 111 and a second docking space 112. The tongue plate 12 has a first surface 121, a second surface 122 and a plurality of slots 123. These slots 123 run through the first surface 121 and the second surface 122 of the tongue plate 12. The tongue plate 12 is fixed on a sidewall of a bottom part 115 of the main body 11 and extended toward the front side. The circuit board 14 has a first surface 141, a second surface 142, and a plurality of grooves 143. These grooves 143 run through the first surface 141 and the second surface 142 of the circuit board 14.

In this embodiment, the circuit board 14 is accommodated within a receiving space 15, which is located under the second surface 122 of the tongue plate 12 (see FIGS. 4 and 5). The first surface 141 of the circuit board 14 is arranged beside the second surface 122 of the tongue plate 12. Of course, the first surface 141 of the circuit board 14 and the second surface 122 of the tongue plate 12 may be in close contact with each other. Alternatively, a signal interface may be interposed between the first surface 141 of the circuit board 14 and the second surface 122 of the tongue plate 12, which will be illustrated later.

In this embodiment, since the tongue plate 12 is fixed on the sidewall of the bottom part 115 of the main body 11 and extended from the main body 11 and the circuit board 14 is accommodated within the receiving space 15 under the second surface 122 of the tongue plate 12, the circuit board 14 is not protruded outside the main body 11.

Moreover, a first signal interface 16 is installed on the circuit board 14 or disposed within the second docking space 112, which is arranged beside the second surface 142 of the circuit board 14. A second signal interface 17 is arranged beside the first signal interface 16, and installed on the circuit board 14 or disposed within the second docking space 112. The second signal interface 17 is also penetrated through the slots 123 of the tongue plate 12 and the grooves 143 of the circuit board 14. Consequently, a contact resilience arm segment 171 of the second signal interface 17 is disposed within the first docking space 111, which is arranged beside the first surface 121 of the tongue plate 12.

In this embodiment, the main body 11 is a plastic main body. In addition, the tongue plate 12 is a plastic tongue plate, for example a fixed plastic tongue plate. The circuit board 14 is a printed circuit board, for example a removable circuit board. Consequently, the first surface 121 and the second surface 122 of the tongue plate 12 may be also referred as a first plastic surface and a second plastic surface, respectively.

Moreover, the plastic main body 11 has two lateral walls 113 and 114, which are extended toward the front side. The two lateral walls 113, 114 and the bottom part 115 of the main body 11 collectively define a docking recess 116. In addition, the plastic tongue plate 12 and the circuit board 14 within the docking recess 116 collectively define the first docking space 111 and the second docking space 112. Moreover, since the slots 123 of the plastic tongue plate 12 and the grooves 143 of the circuit board 14 are aligned with each other, the first docking space 111 and the second docking space 112 are in communication with each other through the slots 123 and the grooves 143.

In this embodiment, the first docking space 111 and the second docking space 112 are defined by the plastic tongue plate 12, the circuit board 14 and the main body 11 (e.g. the two lateral walls 113 and 114).

In this embodiment, the plastic tongue plate 12 is located over the circuit board 14. That is, the first docking space 111 is a lateral space (e.g. an upper space) beside the first plastic surface 121 and excluding the first plastic surface 121. The second docking space 112 is another lateral space (e.g. a lower space) beside the second surface 142 of the circuit board 14 and excluding the second surface 142 of the circuit board 14.

Moreover, the electrical receptacle 10 further comprises a beveled edge structure 13, which is located at a front end 120 of the plastic tongue plate 12 and a front end 140 of the circuit board 14. The beveled edge structure 13 may facilitate the electrical plug 20 (see FIG. 5) to be accommodated within the first docking space 111 or the second docking space 112.

In this embodiment, the beveled edge structure 13 has a vertical bulge 131. The vertical bulge 131 is extended from the front end 120 of the plastic tongue plate 12 to block the front end 140 and a part of the lateral edge of the circuit board 14. The vertical bulge 131 further has an engaging structure 1311. The engaging structure 1311 is disposed on an inner surface of the vertical bulge 131 and arranged beside the front end 140 of the circuit board 14. Consequently, the front end 140 of the circuit board 14 may be interference-fitted to the engaging structure 1311. An example of the engaging structure 1311 is a concave structure.

In such way, as shown in FIG. 5, the receiving space 15 is at least defined by the second plastic surface 122, the bottom part 115 of the plastic main body 11 and the vertical bulge 131.

Alternatively, in another embodiment (not shown), the receiving space 15 is at least defined by the second plastic surface 122 and the vertical bulge 131. Under this circumstance, the circuit board 14 is not in contact with the bottom part 115 of the plastic main body 11.

Alternatively, the beveled edge structure 13 is a single mechanism (not shown) coupled with the front end 120 of the plastic tongue plate 12. In addition, the beveled edge structure 13 has a vertical bulge 131 to block the front end 140 of the circuit board 14.

Moreover, in this embodiment, the electrical receptacle 10 further comprises an individual pressing plate (also referred as a pressing structure) 18. The pressing plate 18 is attached on a rear end of the second surface 142 of the circuit board 14 and coupled with the plastic main body 11. By the pressing plate 18, the circuit board 14 is confined and fixed within the receiving space 15.

In this embodiment, the electrical receptacle 10 further comprises a metallic casing 19, which is sheathed around the outer periphery of the plastic main body 11.

In this embodiment, the first signal interface 16 and the second signal interface 17 are an eSATA signal interface and a USB 2.0 signal interface, respectively. Moreover, the entrance of the docking recess at least comprises a shared profile 1161 mating with various signal interfaces (e.g. an eSATA signal interface and a USB 2.0 signal interface) of a corresponding electrical plug 200 (see FIG. 5). It is preferred that the shared profile 1161 is located at the front peripheries of the two lateral walls 113 and 114.

Moreover, according to the circuitry layout of the circuit board, the eSATA signal interface 16 and the USB 2.0 signal interface 17 have various configurations.

Please refer to FIGS. 4 and 5 again. From front to back, the eSATA signal interface 16 successively comprises a plurality of contact pads 161, a plurality of extension wires 162, and a plurality of pin segments 163. The contact pads 161 are disposed on the second surface 142 of the circuit board 14. The extension wires 162 are electrically connected with respective contact pads 161. The pin segments 163 are welded on respective extension wires 162.

In another embodiment (not shown), from front to back, the eSATA signal interface successively comprises a plurality of contact pads, a plurality of extension segments, and a plurality of pin segments. The contact pads are disposed on the second surface 142 of the circuit board 14. The extension segments are disposed on the second surface 142 of the circuit board 14 or within the second docking space 112. The pin segments are electrically connected with respective extension segments.

Please refer to FIGS. 4 and 5 again. From front to back, the USB 2.0 signal interface 17 successively comprises a plurality of contact resilience arm segments 171, a plurality of extension segments 172, and a plurality of pin segments 173. The extension segments 172 are electrically connected with respective contact resilience arm segments 171 and welded on the second surface 142 of the circuit board 14. The pin segments 173 are electrically connected with respective extension segments 172. That is, the USB 2.0 signal interface 17 comprises a plurality of USB 2.0 conductive terminals, but the extension segments 172 are welded on the second surface 142 of the circuit board 14.

In another embodiment (not shown, but will be described in the second embodiment), from front to back, the USB 2.0 signal interface successively comprises a plurality of contact resilience arm segments, a plurality of extension segments, and a plurality of pin segments. The extension segments are electrically connected with respective contact resilience arm segments and disposed within the second docking space 122. The pin segments are electrically connected with respective extension segments. That is, the USB 2.0 signal interface 17 also comprises a plurality of USB 2.0 conductive terminals, but the extension segments 172 are disposed within the second docking space 122.

In a further embodiment (not shown), from front to back, the USB 2.0 signal interface successively comprises a plurality of contact resilience arm segments, a plurality of extension segments, and a plurality of pin segments. The extension segments are electrically connected with respective contact resilience arm segments, and disposed on the second surface 142 of the circuit board 14 or within the second docking space 112. The pin segments are welded on respective extension segments.

In a still embodiment (not shown), from front to back, the USB 2.0 signal interface successively comprises a plurality of contact resilience arm segments, a plurality of extension wires, and a plurality of pin segments. The extension wires are welded on respective contact resilience arm segments, and disposed on the second surface 142 of the circuit board 14. The pins segments are welded on respective extension wires.

In this embodiment, the pin segments 163 of the eSATA signal interface 16 and pins segments 173 of the USB 2.0 signal interface 17 are fixed on and protruded from the bottom part 115 of the plastic main body 11.

In accordance with a key feature of the present invention, the USB 2.0 signal interface 17 is installed on the second surface 142 of the circuit board 14, wherein the contact resilience arm segments 171 are penetrated through the slots 123 of the tongue plate 12 and the grooves 143 of the circuit board 14, so that the contact resilience arm segments 171 are disposed within and exposed to the first docking space 111. In such way, the spacing interval between the contact resilience arm segment 171 and the extension segment 172 or pin segment 173 on the second surface 142 of the circuit board 14 will be increased, so that the adverse influence of the crosstalk or electromagnetic interference on the interface signals of the USB 2.0 signal interface 17 will be largely reduced. Since the USB 3.0 signal interface with a higher transmission speed may share the USB 2.0 signal interface 17, the performance thereof will be enhanced.

In this embodiment, the contact resilience arm segments 171 of the USB 2.0 signal interface 17 are free ends, which are penetrated through the slots 123 of the tongue plate 12 and the grooves 143 of the circuit board 14. In addition, as shown in FIGS. 3 and 5, the arc-shaped structure 1711 of the contact resilience arm segment 171 is completely exposed to the first docking space. Of course, the front edge of the arc-shaped structure 1711 of the contact resilience arm segment 171 may be sustained against the sidewalls of the slots 123 and the grooves 143 and confined between the plastic tongue plate 12 and the circuit board 14. Whereas, the uppermost edge of the arc-shaped structure 1711 of the contact resilience arm segment 171 is located at the level higher than the slot 123 and the groove 143, and exposed to the first docking space 111.

According to the above configurations, a portion of the USB 2.0 signal interface 17 (e.g. the extension segments 172 and the pin segments 173) and a portion of the eSATA signal interface 16 (e.g. the extension wires 162 and the pin segments 163) are exposed to the second docking space 112. Of course, the both ends of the contact resilience arm segment 171 are respectively exposed to different docking spaces. In this embodiment, one end of the contact resilience arm segment 171 (i.e. the front edge of the arc-shaped structure 1711) is exposed to the first docking space 111, and the other end of the contact resilience arm segment 171 is exposed to the second docking space 112 and electrically connected with the extension segment 172.

Moreover, any signal interface unit of the eSATA signal interface 16 and the USB 2.0 signal interface 17 comprises a single conductive terminal or further comprises a contact pad and an extension wire. According to the specifications of the general electric connector, the signal interface unit should at least comprise three structure segments, including a contact resilience arm segment (a contact pad or a contact segment), an extension segment (or an extension wire), and a pin segment. Due to these three structure segments, the signal interface unit is effective to completely transmit an interface signal. Of course, the structure segments may have different explanations or classifications, which are well known to those skilled in the art.

When compared with the conventional electrical receptacle, the electrical receptacle of the present invention can be assembled more easily. That is, since the circuit board is used for replacing some conductive terminals, the assembling time is saved. Moreover, since the circuit board 14 and the plastic tongue plate 12 are combined together through the receiving space 15, the assembling process is simplified. As shown in FIGS. 3 and 4, the arrows V11 (V12) and H11 (H12) indicate the moving directions of assembling the circuit board 14 and the metallic casing into the plastic main body 11. Moreover, as shown in FIG. 5, the arrow H13 indicates the direction of moving the electrical plug 20 toward the electrical receptacle 10 of the present invention.

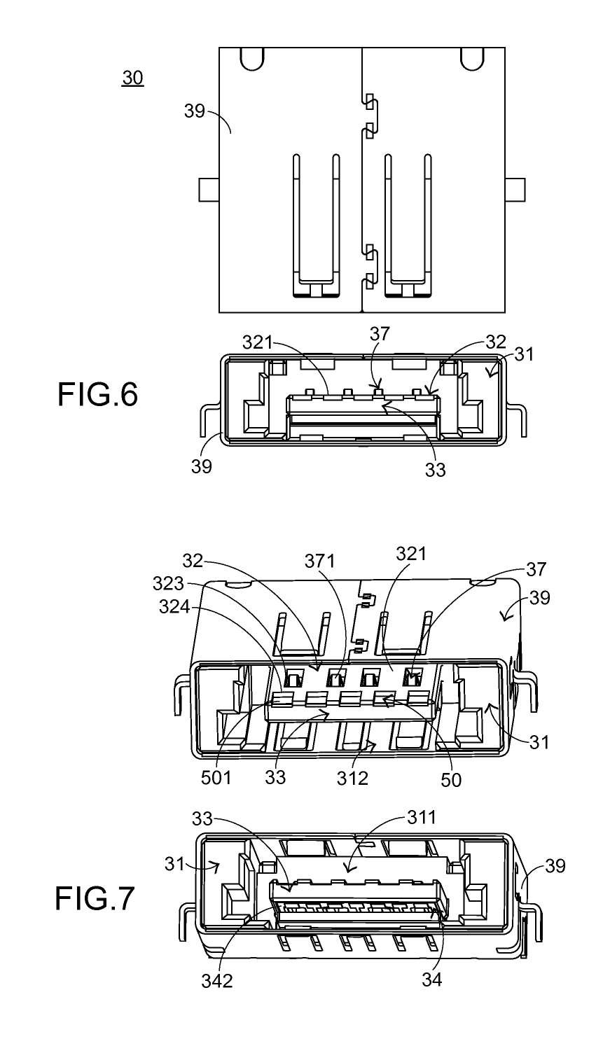

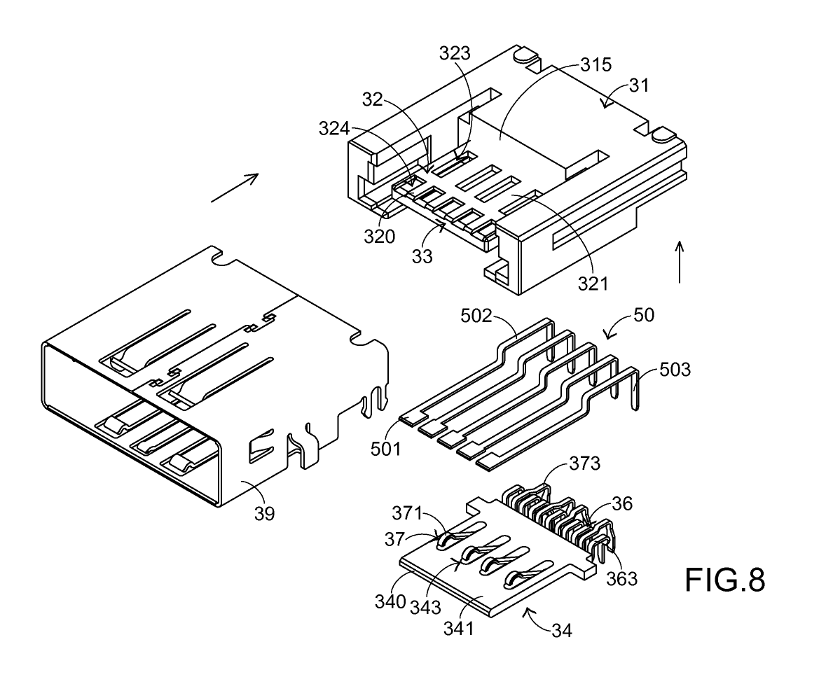

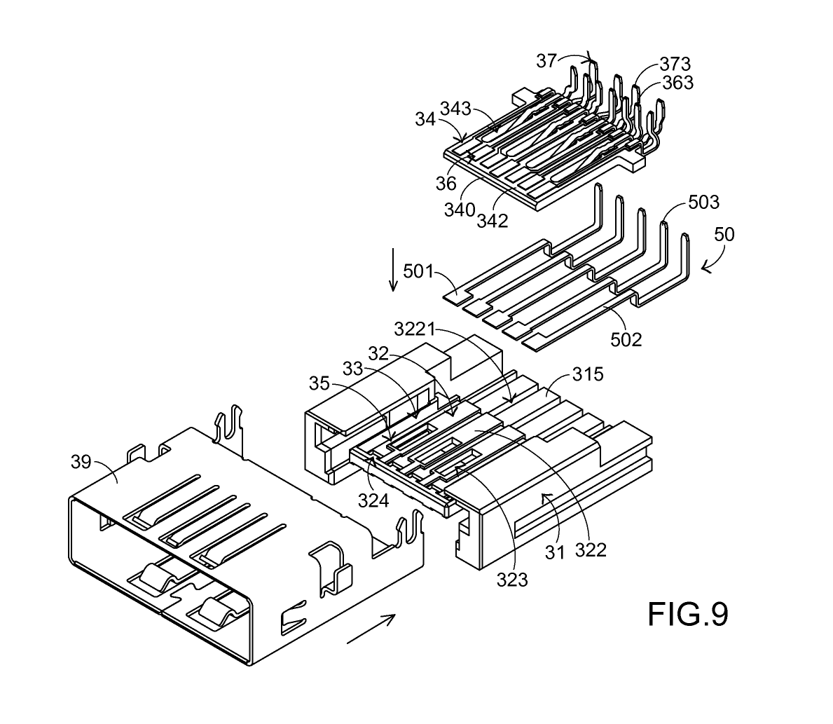

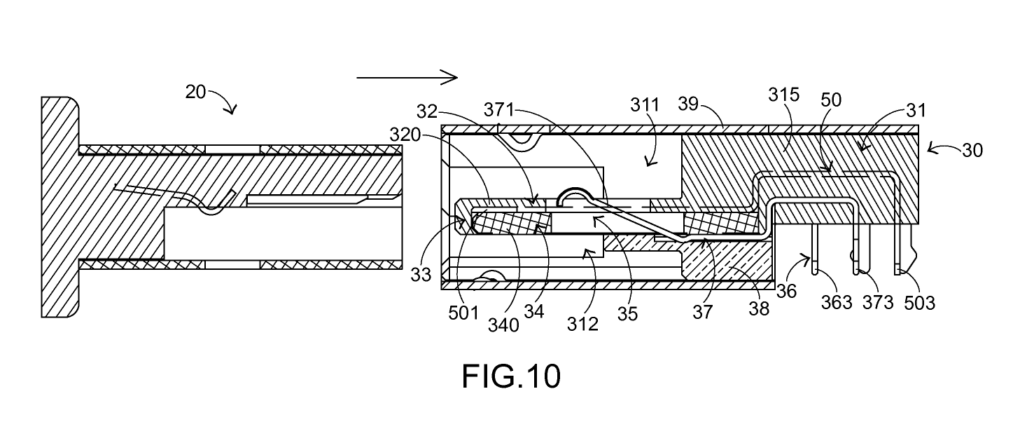

Please refer to FIGS. 6-10. FIG. 6 is a schematic view illustrating a top side and a front side of an electrical receptacle according to a second embodiment of the present invention. FIG. 7 is a schematic three-dimensional view illustrating the electrical receptacle of the second embodiment and taken along different viewpoints. FIG. 8 is a schematic partial exploded view illustrating the electrical receptacle of the second embodiment. FIG. 9 is a schematic partial exploded view illustrating the electrical receptacle of the second embodiment and taken along another viewpoint. FIG. 10 is a schematic side view illustrating the connection between an electrical plug and the electrical receptacle of the second embodiment.

As shown in FIGS. 5-10, the electrical receptacle 30 comprises a main body 31, a tongue plate 32, and a circuit board 34. The main body 31 has a first docking space 311 and a second docking space 312. The tongue plate 32 has a first surface 321, a second surface 322 and a plurality of slots 323. These slots 323 run through the first surface 321 and the second surface 322 of the tongue plate 32. The tongue plate 32 is fixed on a sidewall of a bottom part 315 of the main body 31 and extended toward the front side. The circuit board 34 has a first surface 341, a second surface 342, and a plurality of grooves 343. These grooves 343 run through the first surface 341 and the second surface 342 of the circuit board 34.

In this embodiment, the circuit board 34 is accommodated within a receiving space 35, which is located under the second surface 322 of the tongue plate 32 (see FIGS. 9 and 10). The first surface 341 of the circuit board 34 is arranged beside the second surface 322 of the tongue plate 32. Of course, the first surface 341 of the circuit board 34 and the second surface 322 of the tongue plate 32 may be in close contact with each other. Alternatively, a third signal interface may be interposed between the first surface 341 of the circuit board 34 and the second surface 322 of the tongue plate 32, which will be illustrated later.

Moreover, a first signal interface 36 is installed on the circuit board 34, or disposed within the second docking space 312 beside the second surface 342 of the circuit board 34. A second signal interface 37 is arranged beside the first signal interface 36, and installed on the circuit board 34. The second signal interface 37 is also penetrated through the slots 323 of the tongue plate 32 and the grooves 343 of the circuit board 34. Consequently, the contact resilience arm segment 371 of the second signal interface 37 are disposed within the first docking space 311, which is arranged beside the first surface 321 of the tongue plate 32.

Moreover, the electrical receptacle 30 further comprises a beveled edge structure 33, which is located at a front end 320 of the plastic tongue plate 32 and a front end 340 of the circuit board 34. The beveled edge structure 33 may facilitate the electrical plug 40 (see FIG. 10) to be accommodated within the first docking space 311 or the second docking space 312.

Moreover, in this embodiment, the electrical receptacle 30 further comprises an individual pressing plate (also referred as a pressing structure) 38. The pressing plate 38 is attached on a rear end of the second surface 342 of the circuit board 34 and coupled with the plastic main body 31. By the pressing plate 38, the circuit board 34 is confined and fixed within the receiving space 35.

In this embodiment, the electrical receptacle 30 further comprises a metallic casing 39, which is sheathed around the outer periphery of the plastic main body 31.

In this embodiment, the first signal interface 36 and the second signal interface 37 are an eSATA signal interface and a USB 2.0 signal interface, respectively.

The configurations or arrangements of the above components or the specified implementation examples thereof are similar to those of the first embodiment, and are not redundantly described herein. For example, the main body 31 is a plastic main body, and the tongue plate 32 is a plastic tongue plate.

In comparison with the first embodiment, the electrical receptacle 30 of this embodiment further comprises a third signal interface 50. The third signal interface 50 is arranged between the tongue plate 32 and the circuit board 34. In this embodiment, the third signal interface 50 comprises a plurality of conductive terminals. Moreover, the third signal interface 50 and the USB 2.0 signal interface are collaboratively defined as a USB3.0 signal interface.

In this embodiment, a plurality of contact holes 324 are located at the front end of the tongue plate 32. These contact holes 324 run through the first surface 321 and the second surface 322 of the tongue plate 32 for accommodating respective contact segments 501 of the conductive terminals of the third signal interface 50. Moreover, a plurality of terminal recesses 3221 are formed in the second surface 322 of the tongue plate 32 and extended from the contact holes 324 toward the bottom part 315 of the main body 31. The terminal recesses 3221 are used for fixing and accommodating the extension segments 502 of respective conductive terminals 50, so that the contact terminals 501 received in these contact holes 324 are exposed to the first docking space 311.

Moreover, the pin segments 363 of the first signal interface 36, the pin segments 373 of the second signal interface 37 and the pin segments 503 of the third signal interface 50 are all fixed on and protruded from the bottom part 315 of the main body 31.

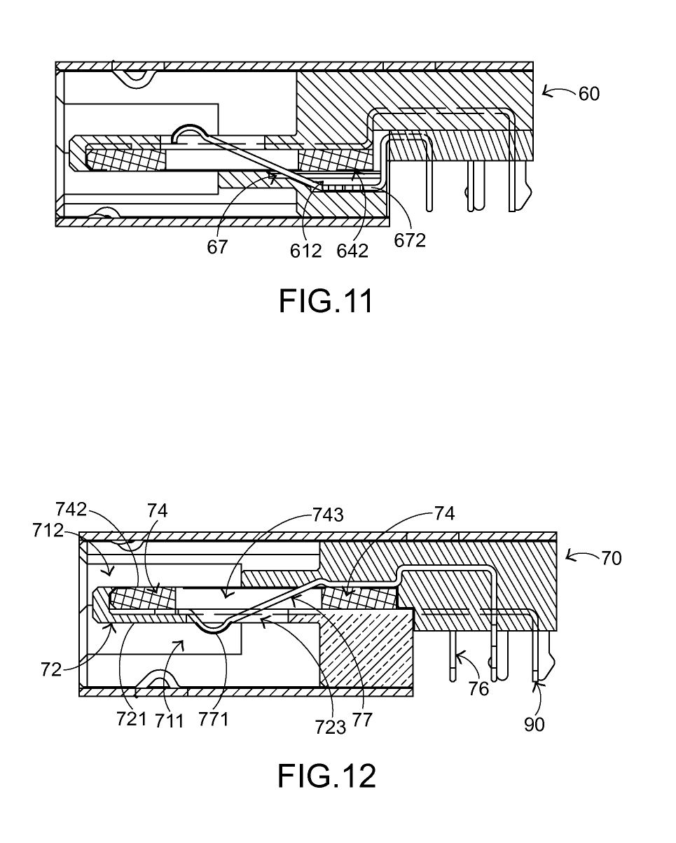

FIG. 11 is a schematic side view illustrating an electrical receptacle according to a third embodiment of the present invention. Except for the following items, the other components and mechanisms of the electrical receptacle of this embodiment are similar to those of the second embodiment, and are not redundantly described herein.

In comparison with the second embodiment, the extension segments 672 of the second signal interface 67 of the electrical receptacle 60 are not disposed on the second surface 642 of the circuit board 64. Whereas, the extension segments 672 of the second signal interface 67 are accommodated within the second docking space 612.

FIG. 12 is a schematic side view illustrating an electrical receptacle according to a fourth embodiment of the present invention. Except for the following items, the other components and mechanisms of the electrical receptacle of this embodiment are similar to those of the second embodiment, and are not redundantly described herein.

As shown in FIG. 12, the tongue plate 72 of the electrical receptacle 70 of this embodiment is located under the circuit board 74. That is, the first docking space 711 is a lower space beside the first surface 721 of the circuit board 74 and excluding the first surface 721 (i.e. a plastic surface). The second docking space 712 is an upper space beside the second surface 742 of the circuit board 74 and excluding the second surface 742 (i.e. a circuit board surface).

Moreover, the second signal interface 77 is arranged beside the first signal interface 76, and installed on the circuit board 74. The second signal interface 77 is also penetrated through the slots 723 of the tongue plate 72 and the grooves 743 of the circuit board 74. Consequently, the contact resilience arm segments 771 of the second signal interface 77 are disposed within the first docking space 711. Moreover, the electrical receptacle 70 further comprises a third signal interface 90.

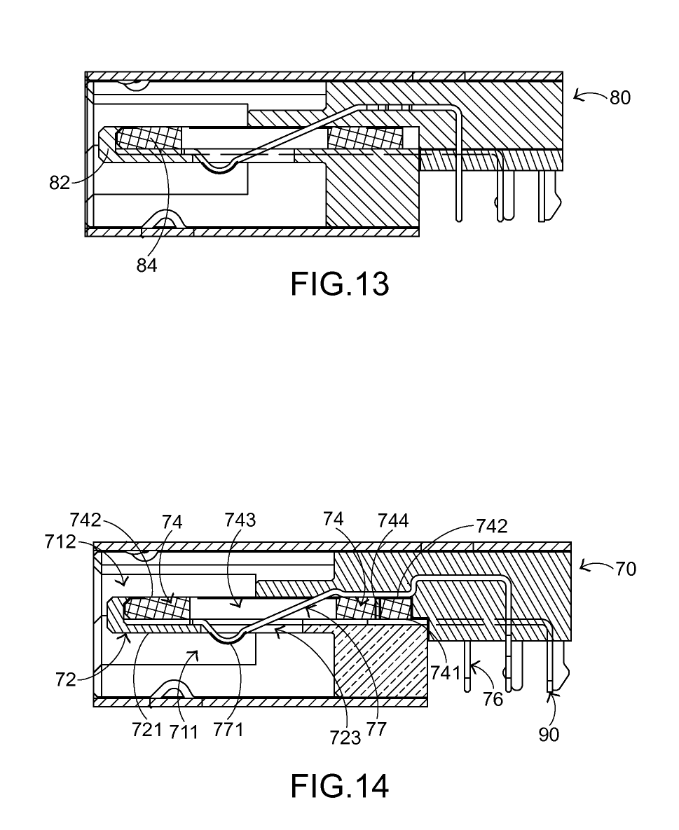

FIG. 13 is a schematic side view illustrating an electrical receptacle according to a fifth embodiment of the present invention. Except for the following items, the other components and mechanisms of the electrical receptacle of this embodiment are similar to those of the third embodiment, and are not redundantly described herein.

In comparison with the third embodiment, the tongue plate 82 of the electrical receptacle 80 of this embodiment is located under the circuit board 84. The other components and mechanisms of the electrical receptacle 80 with respect to the tongue plate 72 and the circuit board 74 are similar to those of the fourth embodiment, and are not redundantly described herein.

FIG. 14 is a schematic side view illustrating an electrical receptacle according to a sixth embodiment of the present invention. Except for the following items, the other components and mechanisms of the electrical receptacle of this embodiment are similar to those of the fourth embodiment, and are not redundantly described herein.

As shown in FIG. 14, the circuit board 74 has a plurality of conductive holes 744 running through the first surface 741 and the second surface 742 of the circuit board 74. The extension wires of the first signal interface 76 that are disposed on the second surface 742 of the circuit board 74 are electrically connected with the conductive holes 744. In addition, the pin segments of the first signal interface 76 that are disposed on the first surface 741 of the circuit board 74 are welded on respective soldering regions of the conductive holes 744. Consequently, a portion of the structure segments of the first signal interface 76 and a portion of the structure segments of the second signal interface 77 are exposed to the same docking space or disposed on the same surface of the tongue plate.

In the above embodiments, the signal interfaces are all assembled into the plastic main body. In addition, no rear cover is included in the electrical receptacle, and the relationships between the plastic main body, the signal interfaces or the tongue plate are not described. Some other embodiments of the electrical receptacle of the present invention will be illustrated as follows.

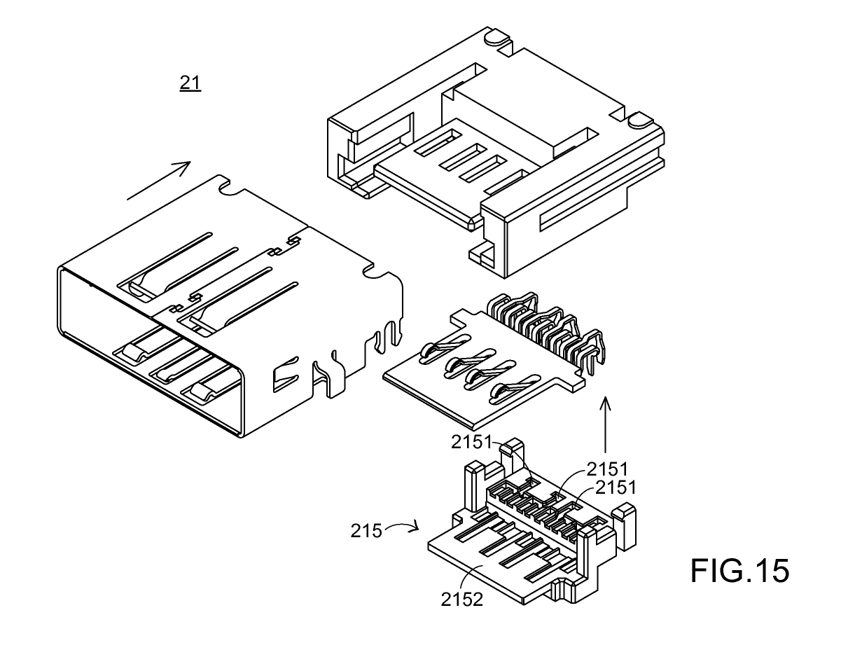

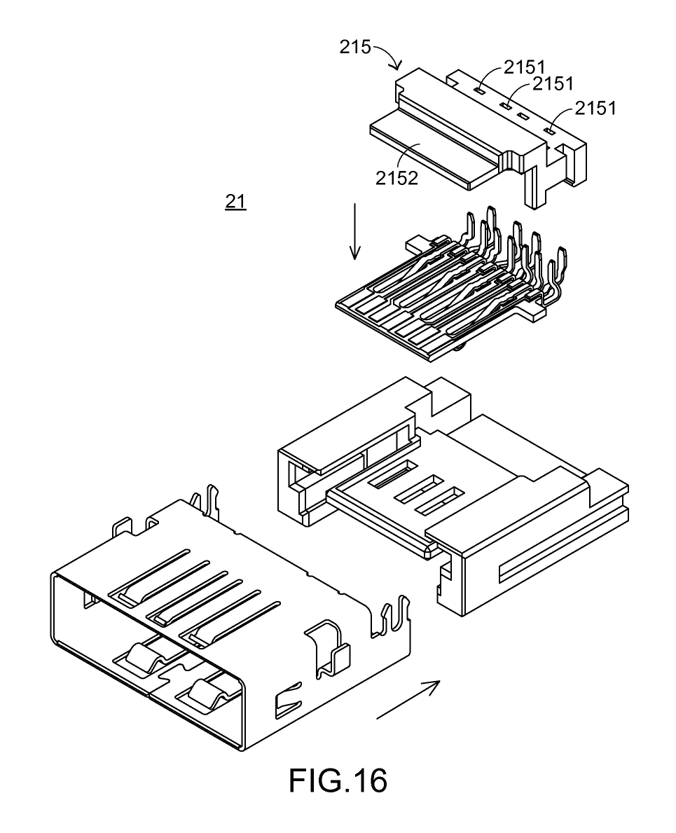

FIG. 15 is a schematic partial exploded view illustrating an electrical receptacle according to a seventh embodiment of the present invention. FIG. 16 is a schematic partial exploded view illustrating the electrical receptacle of the seventh embodiment and taken along another viewpoint. Except for the following items, the other components and mechanisms of the electrical receptacle of this embodiment are similar to those of the first embodiment, and are not redundantly described herein.

In comparison with the first embodiment, the electrical receptacle 21 of this embodiment further comprises a rear cover 215. The rear cover 215 has a plurality of receiving holes 2151 and a pressing plate 2152. The receiving holes 2151 are used for receiving at least a portion of the pin segments of the signal interface. The function of the pressing plate 2152 is substantially identical to the function of the pressing plate 18 of the first embodiment except that the pressing plate 2152 is integrated into the rear cover 215.

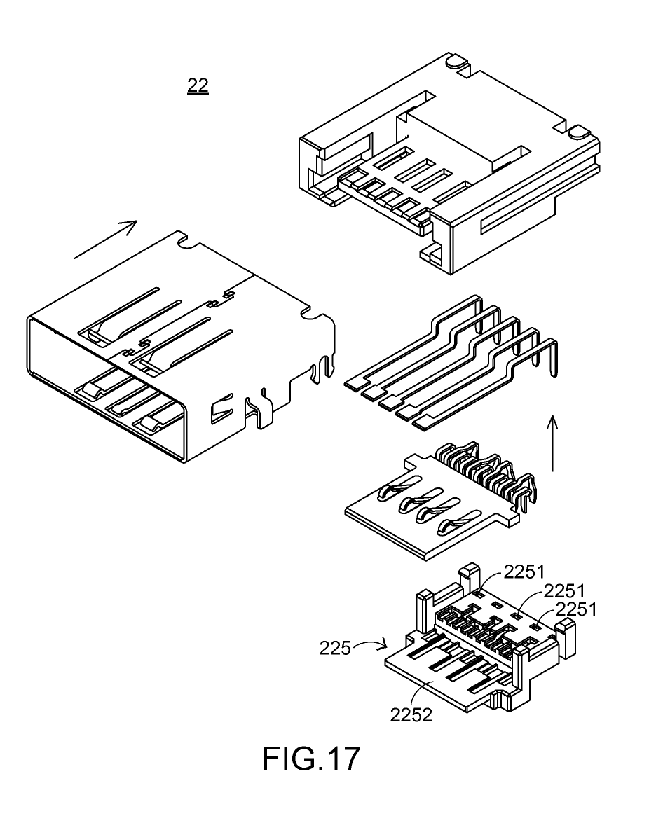

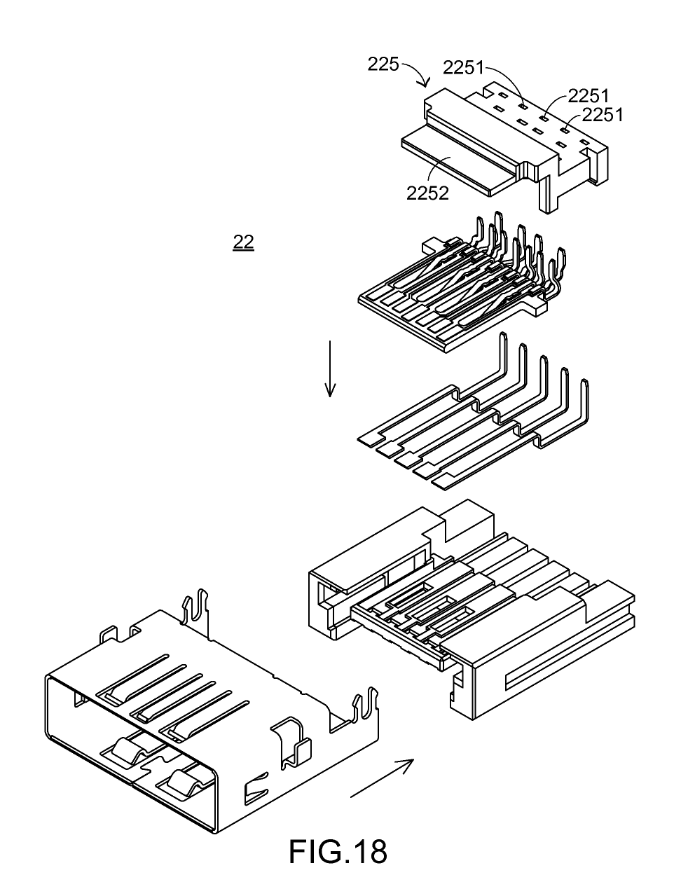

FIG. 17 is a schematic partial exploded view illustrating an electrical receptacle according to an eighth embodiment of the present invention. FIG. 18 is a schematic partial exploded view illustrating the electrical receptacle of the eighth embodiment and taken along another viewpoint. Except for the following items, the other components and mechanisms of the electrical receptacle of this embodiment are similar to those of the second embodiment, and are not redundantly described herein.

In comparison with the second embodiment, the electrical receptacle 22 of this embodiment further comprises a rear cover 225. The rear cover 225 has a plurality of receiving holes 2251 and a pressing plate 2252. The receiving holes 2151 is used for receiving at least a portion of the pin segments of the signal interface. The function of the pressing plate 2252 is identical to the function of the pressing plate 38 of the second embodiment except that the pressing plate 2252 is integrated into the rear cover 225. Moreover, in comparison with the seventh embodiment, the electrical receptacle of this embodiment further comprises a third signal interface.

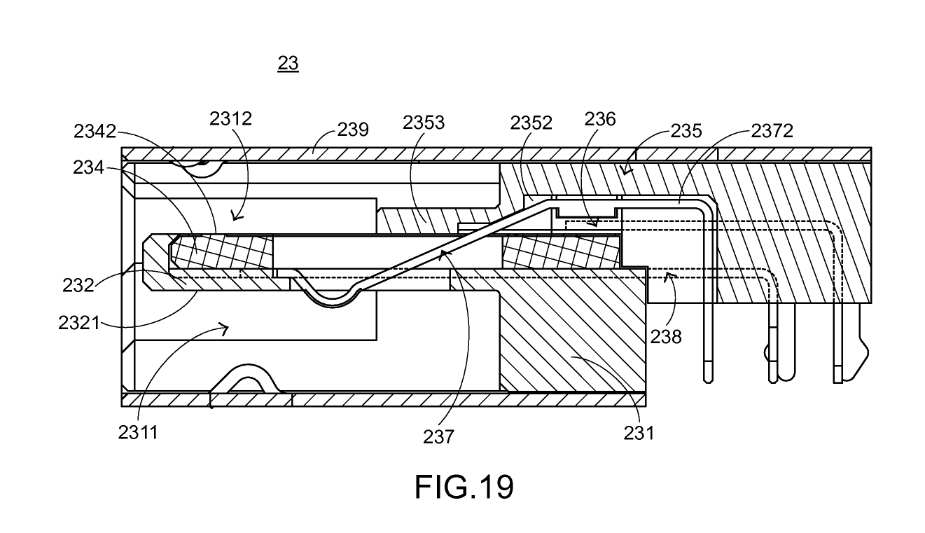

FIG. 19 is a schematic side view illustrating an electrical receptacle according to a ninth embodiment of the present invention. Except for the following items, the other components and mechanisms of the electrical receptacle of this embodiment are similar to those of the eighth embodiment, and are not redundantly described herein.

As shown in FIG. 19, the tongue plate 232 of the electrical receptacle 23 of this embodiment is located under the circuit board 234. That is, the first docking space 2311 is a lower space beside the first surface 2321 of the circuit board 234 and excluding the first surface 2321 (i.e. a plastic surface). The second docking space 2312 is an upper space beside the second surface 2342 of the circuit board 234 and excluding the second surface 742 (i.e. a circuit board surface).

Moreover, the rear cover 235 of the electrical receptacle 23 comprises a plurality of fixing recesses 2352 with position-limiting structures and a pressing plate 2353. The fixing recesses 2352 are used for previously accommodating and fixing at least a portion of the extension segments 2372 of the second signal interface 237. The function of the pressing plate 2353 is identical to the function of the pressing plate of the eighth embodiment, and is not redundantly described herein.

In this embodiment, the second signal interface 237 is previously installed (or previously laminated) on the rear cover 235. Moreover, an end of the pin segment 2363 of the first signal interface 236 is welded on the extension wire (not shown, but can be referred to the first embodiment) of the first signal interface 236 on the circuit board 234, so that the electrical connection between the extension wire and the pin segment 2363 is established.

A process of installing the above signal interfaces to assemble the electrical receptacle 23 will be illustrated as follows. Firstly, the third signal interface 238 is installed on the plastic main body 231. Then, the circuit board 234 along with the first signal interface 236 is installed on the plastic main body 231. Then, the rear cover 235 along with the second signal interface 237 is installed on the plastic main body 231. After the metallic casing 239 is sheathed around the outer periphery of the plastic main body 231, the electrical receptacle 23 is assembled.

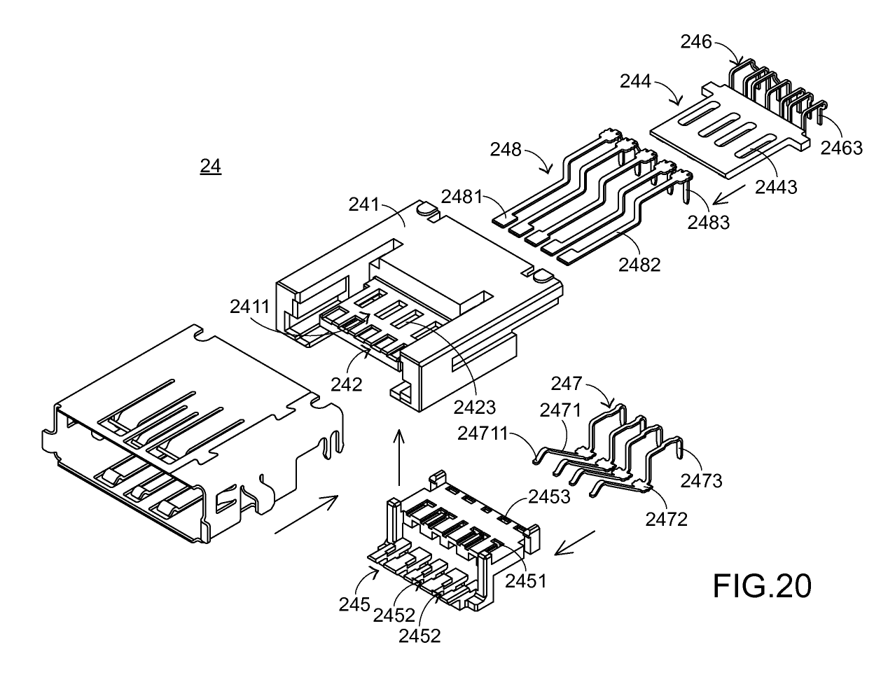

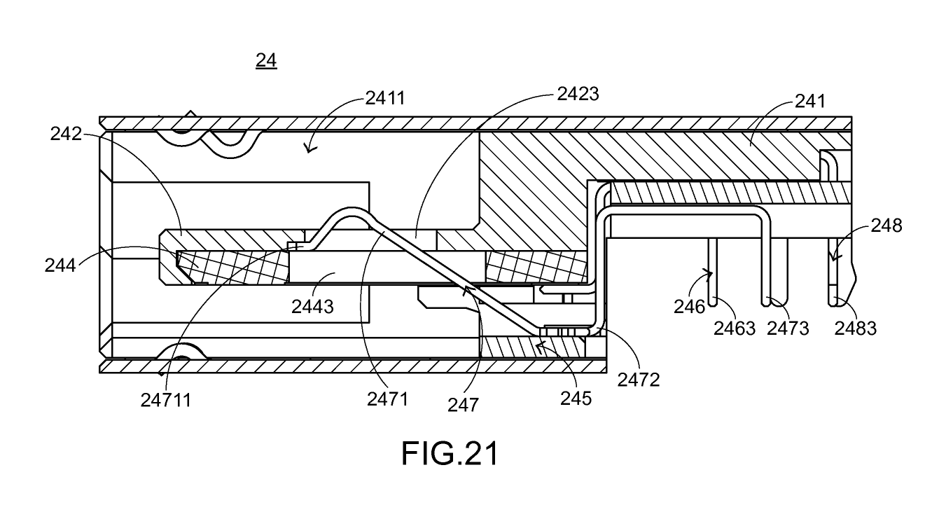

FIG. 20 is a schematic partial exploded view illustrating an electrical receptacle according to a tenth embodiment of the present invention. FIG. 21 is a schematic side view illustrating the electrical receptacle of the tenth embodiment. Except for the following items, the other components and mechanisms of the electrical receptacle of this embodiment are similar to those of the second embodiment, and are not redundantly described herein.

In comparison with the second embodiment, the extension segments 2472 of the second signal interface 247 of the electrical receptacle 24 are previously accommodated within the fixing recesses 2452 of the rear cover 245. Consequently, during the process of assembling the electrical receptacle 24, the rear cover 245 along with second signal interface 247 is installed on the plastic main body 241.

Moreover, in comparison with the second embodiment, a front end of the contact resilience arm segment 2471 of the second signal interface 247 has a contact part 24711. Consequently, after the second signal interface 247 is penetrated through the grooves 2443 of the circuit board 244 with the first signal interface 246 and installed on the circuit board 244, the contact parts 24711 are hooked to the slots 2423 of the tongue plate 242. Consequently, a portion of the contact resilience arm segments 2471 are exposed to the first docking space 2411 (see FIG. 21). That is, the contact resilience arm segments 2471 are not completely exposed to the first docking space 2411.

In this embodiment, the contact segments 2481 and the extension segments 2482 of the third signal interface 248 are accommodated within the tongue plate 242. Moreover, the pin segments 2483 of the third signal interface 248 and the pin segments 2463 of the first signal interface 246 are penetrated through the receiving holes 2453 and 2451, respectively. That is, the rear cover 245 comprises the fixing recesses 2452 and the receiving holes 2453, 2451.

Moreover, the pin segments 2473 of the second signal interface 247 are exposed outside the rear cover 245, and are not accommodated within the main body 241 or the other plastic structural body.

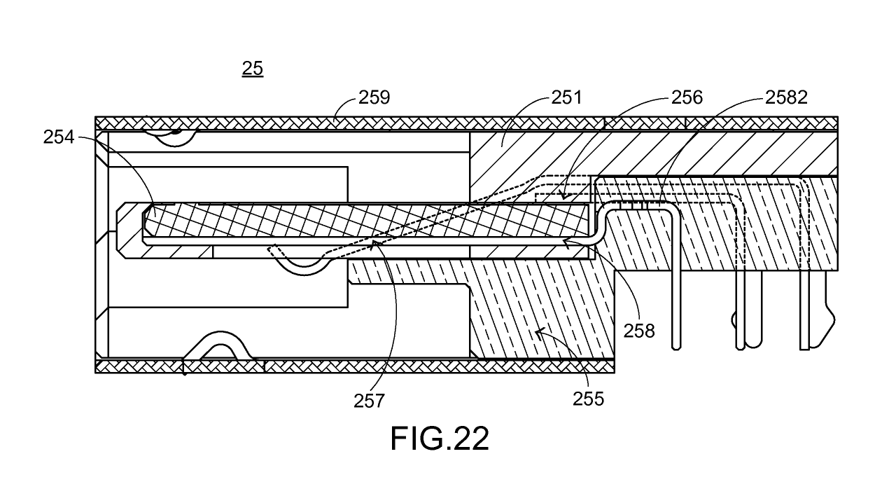

FIG. 22 is a schematic side view illustrating an electrical receptacle according to an eleventh embodiment of the present invention. Except for the following items, the other components and mechanisms of the electrical receptacle of this embodiment are similar to those of the ninth embodiment, and are not redundantly described herein.

In comparison with the ninth embodiment, the rear cover 255 of the electrical receptacle 25 of this embodiment is located under the plastic main body 251. Moreover, the extension segments 2582 of the third signal interface 258 are previously installed on the rear cover 255. A process of assembling the electrical receptacle 25 will be illustrated as follows. Firstly, the circuit board 254 and the first signal interface 256 welded thereon are installed on the plastic main body 251. Then, the second signal interface 257 is installed on the plastic main body 251. Then, the rear cover 255 along with the third signal interface 258 is installed on the plastic main body 251. After the metallic casing 259 is sheathed around the outer periphery of the plastic main body 251, the electrical receptacle 25 is assembled.

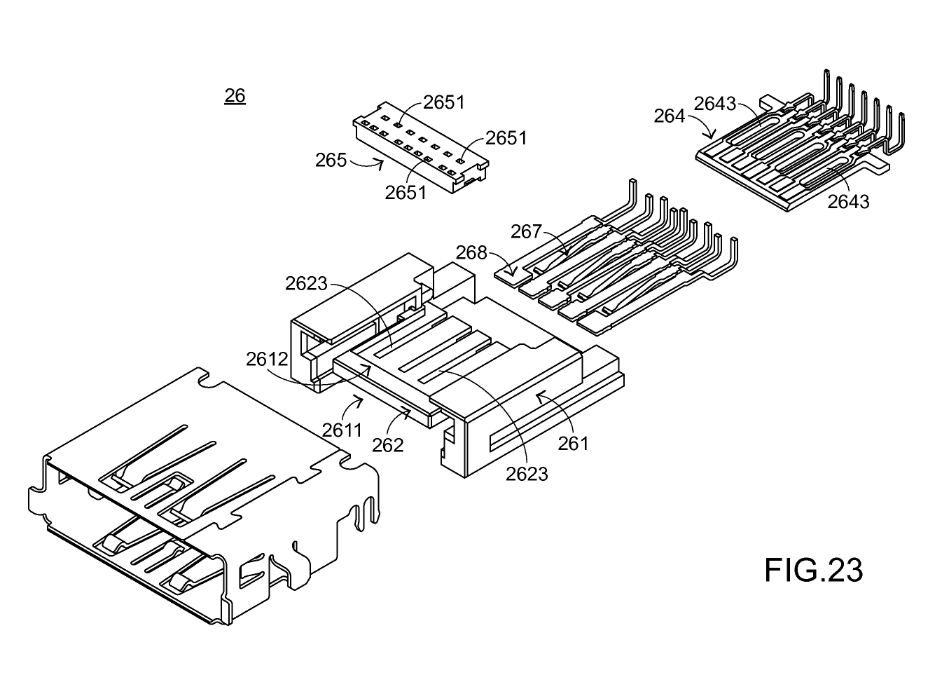

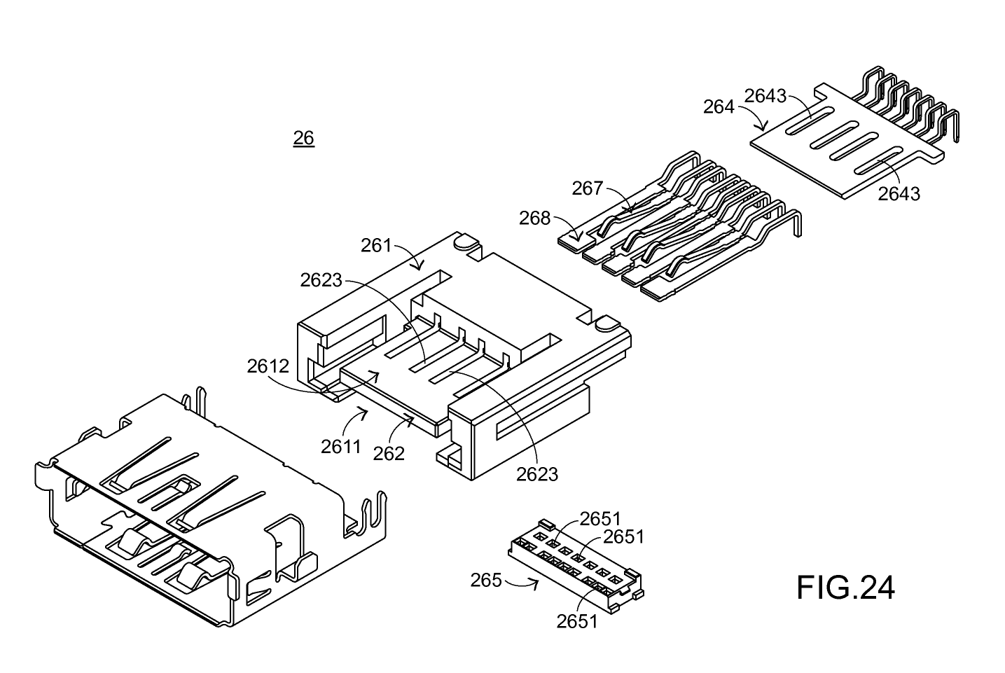

FIG. 23 is a schematic partial exploded view illustrating an electrical receptacle according to a twelfth embodiment of the present invention. FIG. 24 is a schematic partial exploded view illustrating the electrical receptacle of the twelfth embodiment and taken along another viewpoint. Except for the following items, the other components and mechanisms of the electrical receptacle of this embodiment are similar to those of the eighth embodiment, and are not redundantly described herein.

In comparison with the eighth embodiment, the tongue plate 262 of the electrical receptacle 26 of this embodiment is located under the circuit board 264. In other words, the definitions of the first docking space 2611 and the second docking space 2612 are distinguished from those of the eighth embodiment, but are similar to those of the ninth embodiment. Moreover, the rear cover 265 of the electrical receptacle 26 has no pressing plate, but comprises a plurality of receiving holes 2651. The receiving holes 2651 are used for receiving at least a portion of the pin segments of the signal interface.

Moreover, the second signal interface 267 and the third signal interface 268 of the electrical receptacle 26 are directly installed on the tongue plate 262, which is installed on the plastic main body 261. The second signal interface 267 is arranged between the tongue plate 262 and the circuit board 264. Consequently, the second signal interface 267 is not penetrated through the grooves 2643 of the circuit board 264, but only penetrated through the slots 2623 of the tongue plate 262 to be exposed to the first docking space 2611.

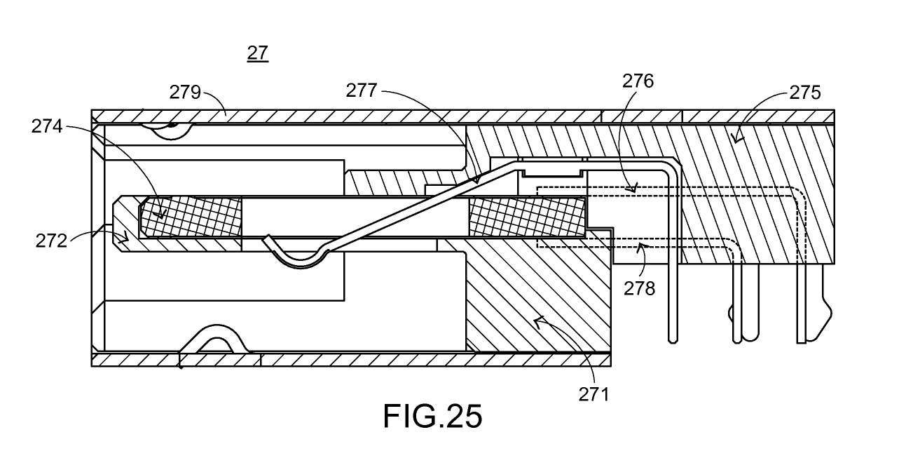

FIG. 25 is a schematic side view illustrating an electrical receptacle according to a thirteenth embodiment of the present invention. Except for the following items, the other components and mechanisms of the electrical receptacle of this embodiment are similar to those of the ninth embodiment, and are not redundantly described herein.

In comparison with the ninth embodiment, the second signal interface 277 is previously installed on the rear cover 275. Moreover, the first signal interface 276 and the third signal interface 278 are respectively welded on the two opposite surfaces of the circuit board 274. A process of installing the above signal interfaces to assemble the electrical receptacle 27 will be illustrated as follows. Firstly, the circuit board 272 along with the first signal interface 276 and the third signal interface 278 is installed on tongue plate 272 of the plastic main body 271. Then, the rear cover 275 along with the second signal interface 277 is installed on the plastic main body 271. After the metallic casing 279 is sheathed around the outer periphery of the plastic main body 271, the electrical receptacle 27 is assembled.

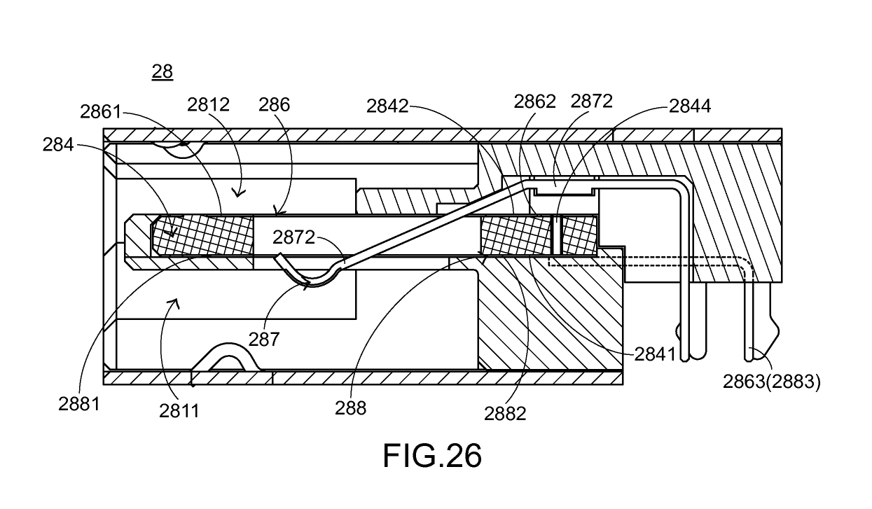

FIG. 26 is a schematic side view illustrating an electrical receptacle according to a fourteenth embodiment of the present invention. Except for the following items, the other components and mechanisms of the electrical receptacle of this embodiment are similar to those of the thirteenth embodiment, and are not redundantly described herein.

In comparison with the thirteenth embodiment, the circuit board 284 of the electrical receptacle 28 of this embodiment has a plurality of conductive holes 2844 running through the first surface 2841 and the second surface 2842 of the circuit board 284. The contact pads 2861 and the extension wires 2862 of the first signal interface 286 are disposed on the second surface 2842 of the circuit board 284, or accommodated within the second docking space 2812 beside the second surface 2842 of the circuit board 284. The pin segments 2863 of the first signal interface 286 are welded on respective soldering regions of the conductive holes 2844 at the first surface 2841 of the circuit board 284. Moreover, the conductive holes 2844 run through the first surface 2841 and the second surface 2842 of the circuit board 284, and are electrically connected with the extension wires 2862. In this embodiment, the pin segments 2863 of the first signal interface 286 and respective pin segments 2883 of the third signal interface 288 are shared with each other.

A portion of the structure segments of the second signal interface 287 (e.g. the last half of the segments 2872) and the contact pads 2861 and the extension wires 2862 of the first signal interface 286 are arranged beside each other and located at the same side of the circuit board 284. That is, a portion of the structure segments of the second signal interface 287 and the contact pads 2861 and the extension wires 2862 of the first signal interface 286 are disposed on the second surface 2842 of the circuit board 284, or disposed within the second docking space 2812 beside the second surface 2842 of the circuit board 284. Moreover, another portion of the structural sections of the second signal interface 287 (e.g. the first half of the segments 2872) and the contact pads 2881 and the extension wires 2882 of the third signal interface 288 are arranged beside each other and located at the same side of the circuit board 284. That is, another portion of the structure segments of the second signal interface 287 and the contact pads 2881 and the extension wires 2882 of the third signal interface 288 are disposed on the first surface 2841 of the circuit board 284, or disposed within the first docking space 2811 beside the first surface 2841 of the circuit board 284.

FIG. 27 is a schematic side view illustrating an electrical receptacle according to a fifteenth embodiment of the present invention. Except for the following items, the other components and mechanisms of the electrical receptacle of this embodiment are similar to those of the twelfth embodiment, and are not redundantly described herein.

In comparison with the twelfth embodiment, the second signal interface 297 of the electrical receptacle 29 of this embodiment is directly installed on the plastic main body 291. Moreover, the second signal interface 297 is arranged between the tongue plate 292 and the circuit board 294. Consequently, the second signal interface 297 is not penetrated through the grooves 2943 of the circuit board 294, but only penetrated through the slots 2923 of the tongue plate 292 to be exposed to the first docking space 2911.

Moreover, the contact pads 2981 and the extension wires 2982 of the third signal interface 298 are disposed on the circuit board 294. The pin segments 2983 of the third signal interface 298 are welded on the extension wires 2982 which are disposed on the circuit board 294.

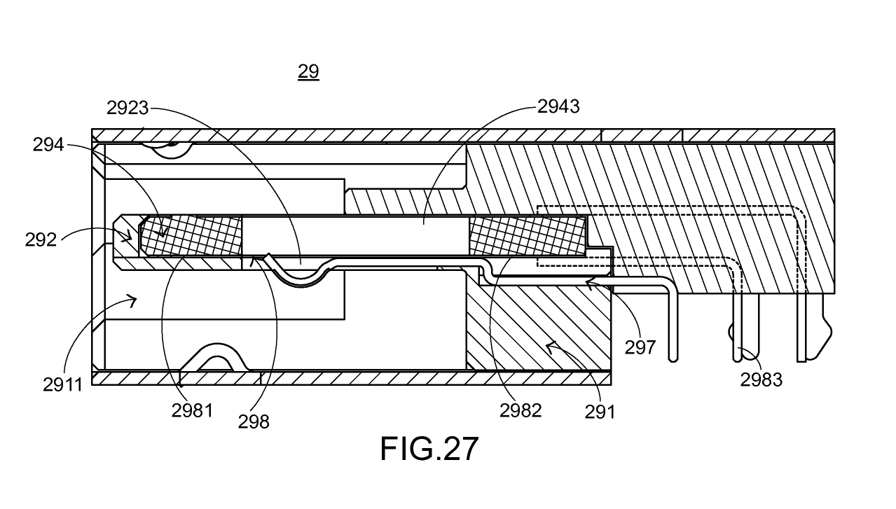

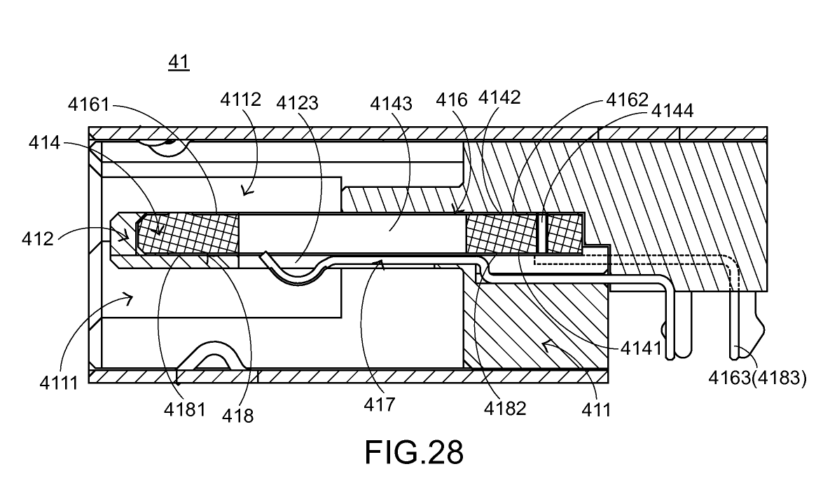

FIG. 28 is a schematic side view illustrating an electrical receptacle according to a sixteenth embodiment of the present invention. Except for the following items, the other components and mechanisms of the electrical receptacle of this embodiment are similar to those of the fourteenth embodiment, and are not redundantly described herein.

In comparison with the fourteenth embodiment, the second signal interface 417 of the electrical receptacle 41 of this embodiment is directly installed on the tongue plate 412 of the plastic main body 411. Moreover, the second signal interface 417 is arranged between the tongue plate 412 and the circuit board 414. Consequently, the second signal interface 417 is not penetrated through the grooves 4143 of the circuit board 414, but only penetrated through the slots 4123 of the tongue plate 412 to be exposed to the first docking space 4111.

Moreover, the contact pads 4161 and the extension wires 4162 of the first signal interface 416 are disposed on the second surface 4142 of the circuit board 414, or accommodated within the second docking space 4112 beside the second surface 4142 of the circuit board 414. The pin segments 4163 of the first signal interface 416 are welded on respective soldering regions of the conductive holes 4144 at the first surface 4141 of the circuit board 414. Moreover, the conductive holes 4144 run through the first surface 4141 and the second surface 4142 of the circuit board 414, and are electrically connected with the extension wires 4162. In this embodiment, the pin segments 4163 of the first signal interface 416 and respective pin segments 4183 of the third signal interface 418 are shared with each other.

The second signal interface 417 and the pin segment 4163 of the first signal interface 416 are arranged beside each other and located at the same side of the circuit board 414. That is, the second signal interface 417 and the pin segment 4163 of the first signal interface 416 are disposed on the first surface 4141 of the circuit board 414, or disposed within the first docking space 4111 beside the first surface 4141 of the circuit board 414. Moreover, the second signal interface 417 and the contact pad 4181 and the extension wire 4182 of the third signal interface 418 are arranged beside each other and exposed to the same docking space (i.e. the first docking space 4111).

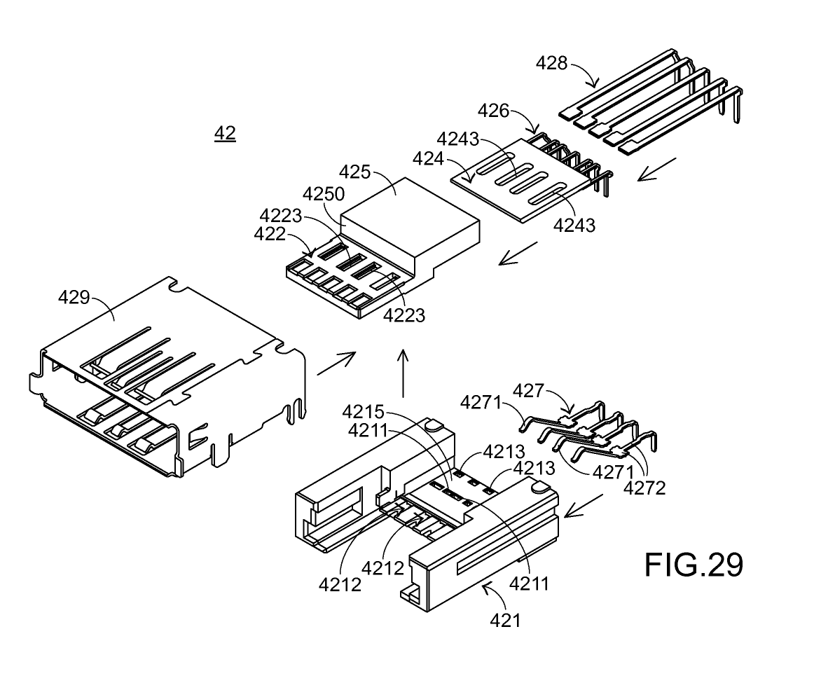

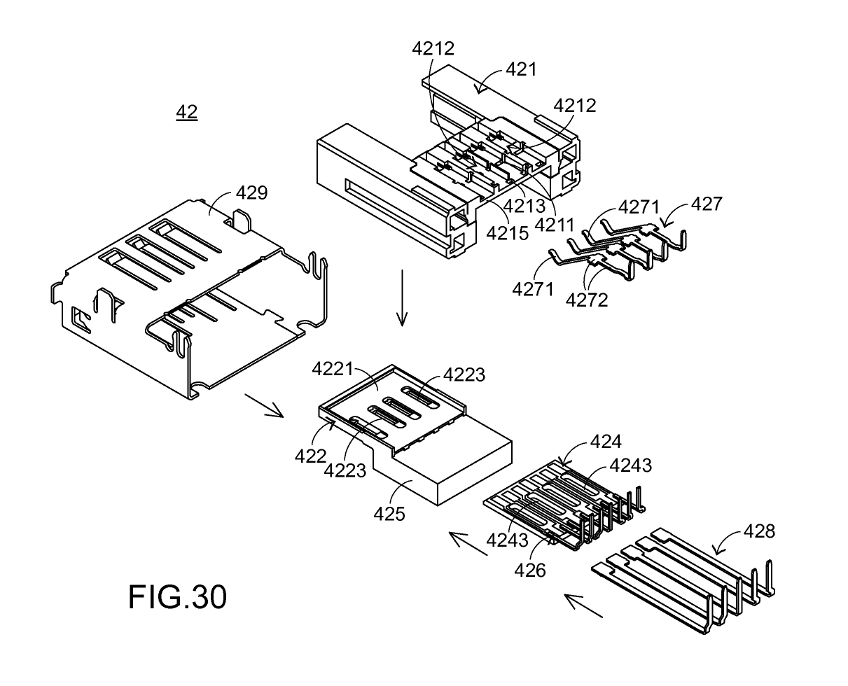

FIG. 29 is a schematic partial exploded view illustrating an electrical receptacle according to a seventeenth embodiment of the present invention. FIG. 30 is a schematic partial exploded view illustrating the electrical receptacle of the seventeenth embodiment and taken along another viewpoint. Except for the following items, the other components and mechanisms of the electrical receptacle of this embodiment are similar to those of the eighth embodiment, and are not redundantly described herein.

In comparison with the eighth embodiment, the tongue plate 422 of the electrical receptacle 42 of this embodiment is a removable plastic tongue plate. Moreover, the tongue plate 422 and the plastic main body 421 are combined together in an up/down stacking manner or other suitable means. In addition, the tongue plate 422 is integrally formed with the rear cover 424. A sidewall 4250 of the rear cover 424 is arranged beside at least one docking space (not shown).

Moreover, the plastic main body 421 has a thin bottom part 4215, and a plurality of fixing recesses 4212 with position-limiting structure are formed in the bottom part 4215. The extension segments 4272 of the second signal interface 427 of the electrical receptacle 42 are accommodated within the fixing recesses 4212. Moreover, the bottom part 4215 of the plastic main body 421 further comprises receiving holes 4211 and 4213 for accommodating the pin segments of the first signal interface 426 and the third signal interface 428, respectively.

A process of assembling the electrical receptacle will be illustrated as follows. Firstly, the third signal interface 428 is installed on the tongue plate 422. Then, the circuit board 424 with the first signal interface 426 welded thereon is accommodated within the receiving space 4221 of the tongue plate 42. Then, the tongue plate 42 and the plastic main body 421 along with the second signal interface 427 are combined together. After the metallic casing 429 is sheathed around the outer periphery of the plastic main body 421, the electrical receptacle 42 is assembled.

Of course, in this embodiment, the contact resilience arm segments 4271 of the second signal interface 427 are successively penetrated through the grooves 4243 of the circuit board 424 and the slots 4223 of the tongue plate 422.

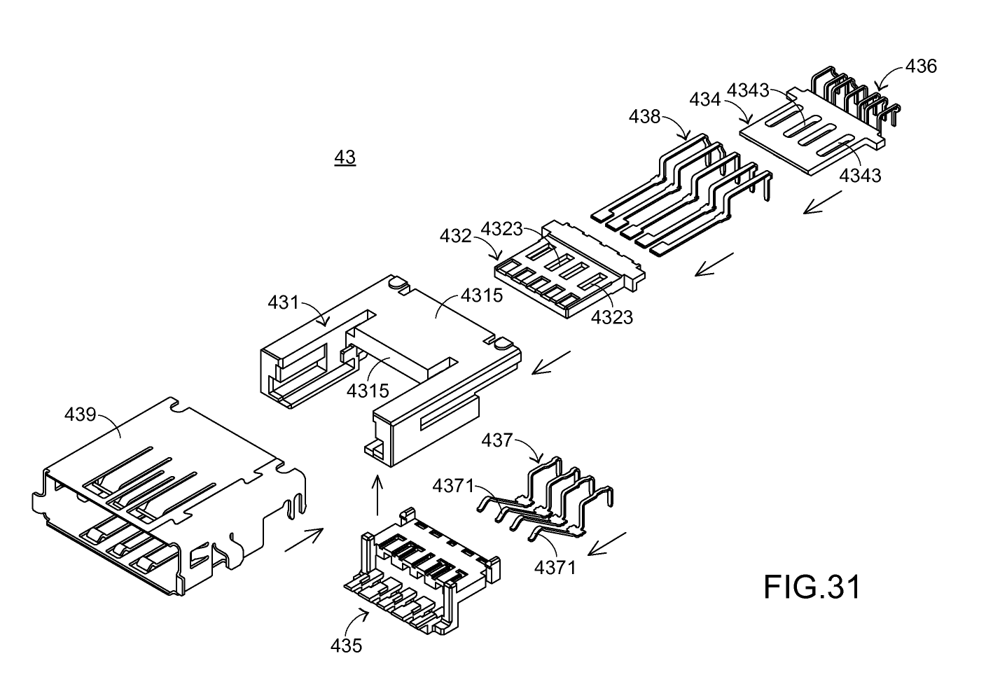

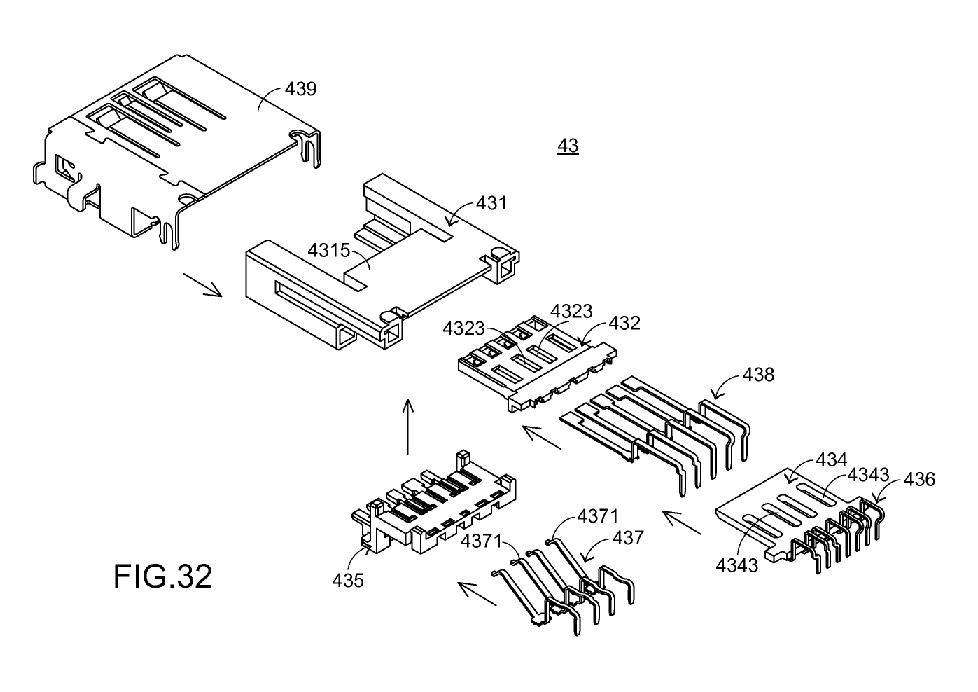

FIG. 31 is a schematic partial exploded view illustrating an electrical receptacle according to an eighteenth embodiment of the present invention. FIG. 32 is a schematic partial exploded view illustrating the electrical receptacle of the eighteenth embodiment and taken along another viewpoint. Except for the following items, the other components and mechanisms of the electrical receptacle of this embodiment are similar to those of the seventeenth embodiment, and are not redundantly described herein.

In comparison with the seventeenth embodiment, the tongue plate 432 of the electrical receptacle 43 of this embodiment is an individual component (e.g. a removable plastic tongue plate). Moreover, the tongue plate 432 can be combined with the bottom part 4315 of the plastic main body 431. The second signal interface 437 of the electrical receptacle 43 is previously installed on the rear cover 435.

A process of assembling the electrical receptacle 43 will be illustrated as follows. Firstly, the third signal interface 438 is installed on the tongue plate 432. Then, the circuit board 436 with the first signal interface 436 welded thereon is accommodated within the receiving space 4321 of the tongue plate 432. Then, the tongue plate 432 and the plastic main body 431 are combined together. Then, the rear cover 435 along with the second signal interface 437 is installed on the plastic main body 431. After the metallic casing 439 is sheathed around the outer periphery of the plastic main body 431, the electrical receptacle 43 is assembled.

Of course, in this embodiment, the contact resilience arm segments 4371 of the second signal interface 437 are successively penetrated through the grooves 4343 of the circuit board 434 and the slots 4323 of the tongue plate 432.

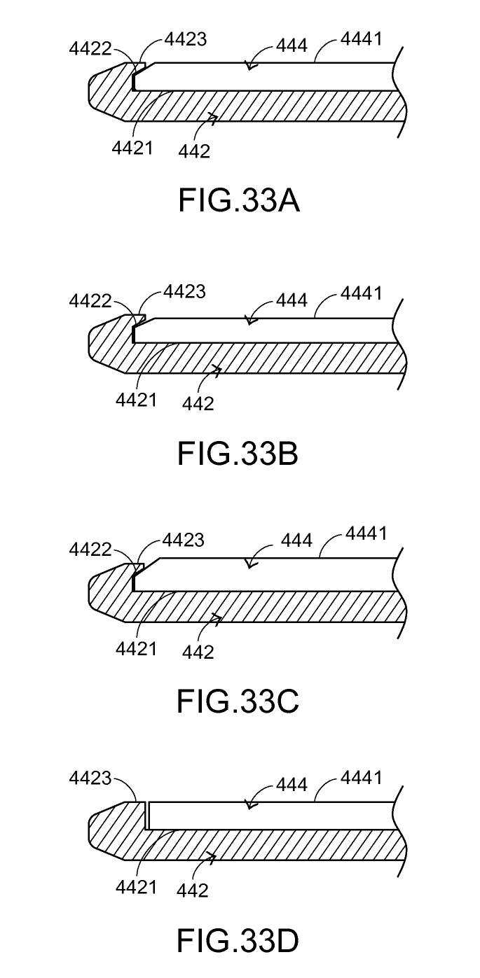

FIGS. 33A-33D are schematic side views illustrating the relationships between the tongue plate and the circuit board for various exemplary electrical receptacles of the present invention. From top to bottom, the relationships between the tongue plate 442 and the circuit board 444 will be described in FIGS. 33A-33D. As shown in FIG. 33A, the circuit board 444 is accommodated within the receiving space 4421 of the plastic tongue plate 442. Moreover, the circuit board 444 is fixed within the receiving space 4421 by means of the engaging structure 4422 (e.g. the concave structure). In this example, the altitude of the top surface 4423 of the vertical bulge of the tongue plate 442 is equal to the altitude of the second surface 4441 of the circuit board 444.

As shown in FIG. 3B, the circuit board 444 is also accommodated within the receiving space 4421 of the plastic tongue plate 442. Moreover, the circuit board 444 is fixed within the receiving space 4421 by means of the engaging structure 4422 (e.g. the concave structure). In this example, the altitude of the second surface 4441 of the circuit board 444 is slightly lower than the altitude of the top surface 4423 of the vertical bulge of the tongue plate 442.

As shown in FIG. 3C, the circuit board 444 is also accommodated within the receiving space 4421 of the plastic tongue plate 442. Moreover, the circuit board 444 is fixed within the receiving space 4421 by means of the engaging structure 4422 (e.g. the concave structure). In this example, the altitude of the second surface 4441 of the circuit board 444 is slightly higher than the altitude of the top surface 4423 of the vertical bulge of the tongue plate 442.

As shown in FIG. 3D, the circuit board 444 is also accommodated within the receiving space 4421 of the plastic tongue plate 442. In this example, the altitude of the second surface 4441 of the circuit board 444 is equal to the altitude of the top surface 4423 of the vertical bulge of the tongue plate 442. In comparison with the above three examples, the plastic tongue plate 442 of this example has no engaging structure (e.g. the concave structure). That is, the circuit board 444 is only accommodated within the receiving space 4421 but not fixed within the receiving space 4421. Of course, those skilled in the art will readily observe that numerous modifications and alterations may be made while retaining the teachings of the invention. For example, other position-limiting structure may be used for confining the circuit board 444 within the receiving space 4421.

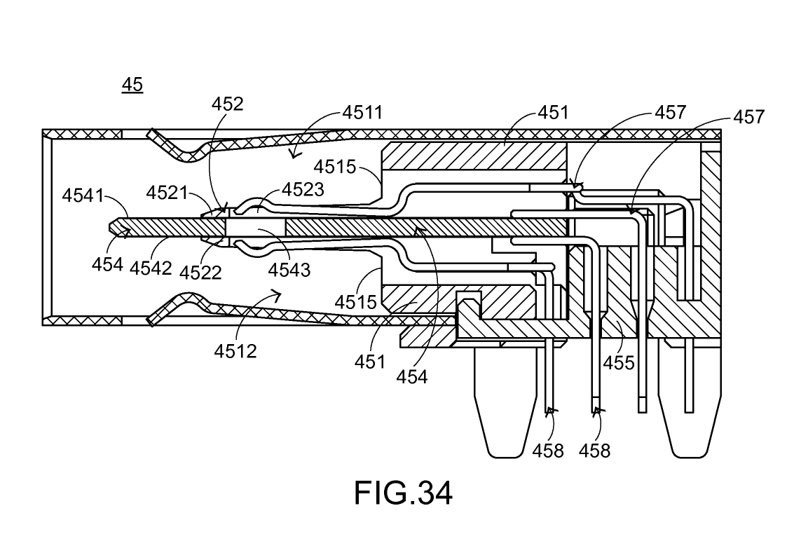

FIG. 34 is a schematic side view illustrating an electrical receptacle according to a nineteenth embodiment of the present invention. As shown in FIG. 34, the electrical receptacle 45 of this embodiment comprises a main body 451, a tongue plate 452, a circuit board 454, and a rear cover 455. The main body 41 has a first docking space 411 and a second docking space 412. The tongue plate 452 has a first surface 4521, a second surface 4522 and a plurality of slots 4523, wherein these slots 4523 run through the first surface 4521 and the second surface 4522. The tongue plate 452 is fixed on a sidewall of a bottom part 4515 of the main body 451 and extended toward the front side. The circuit board 454 has a first surface 4541, a second surface 4542, and a plurality of grooves 4543, wherein these grooves 4543 run through the first surface 4541 and the second surface 4542.

In comparison with the first embodiment, the receiving space for accommodating the circuit board 454 (i.e. the position of the circuit board 454) is located within the tongue plate 452 and arranged between the first surface 4521 and the second surface 4522 of the tongue plate 452. Moreover, a USB3.0 signal interface 457 is disposed on the first surface 4522 of the tongue plate 452 and arranged beside the first docking space 4511. Another USB3.0 signal interface 458 is disposed on the second surface 4522 of the tongue plate 452 and arranged beside second first docking space 4512. In such way, an electrical plug may be inserted into the electrical receptacle in a bidirectional conducting manner. That is, the electrical plug may be inserted into the electrical receptacle in a forward or reverse docking direction without the need of using the foolproof profile. Alternatively, in some embodiments, the electrical receptacle may have USB2.0 signal interfaces, so that an electrical plug may be inserted into the electrical receptacle in a bidirectional conducting manner.

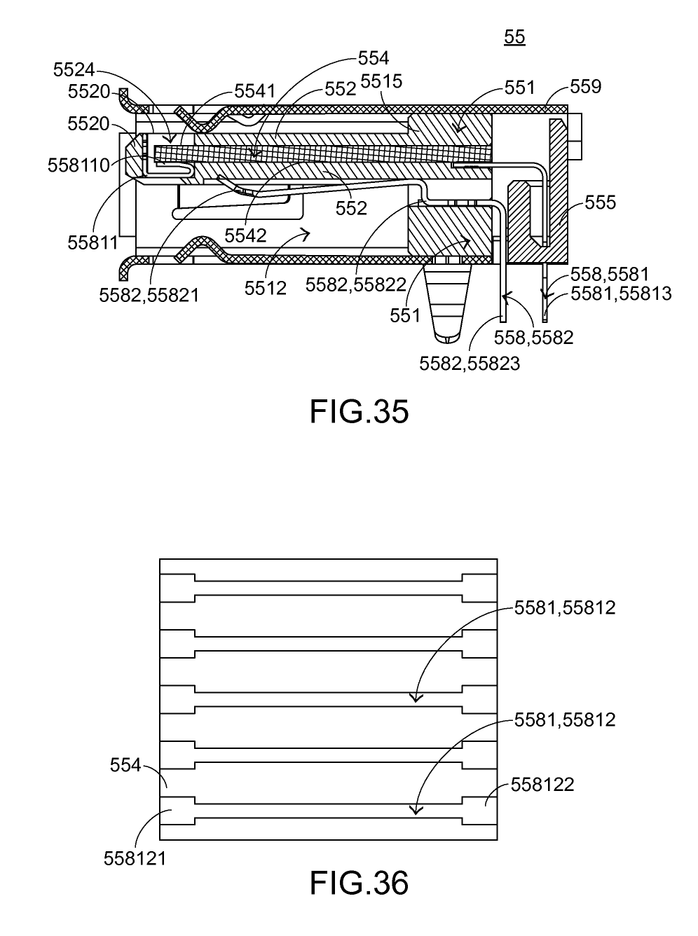

FIG. 35 is a schematic side view illustrating an electrical receptacle according to a twentieth embodiment of the present invention.

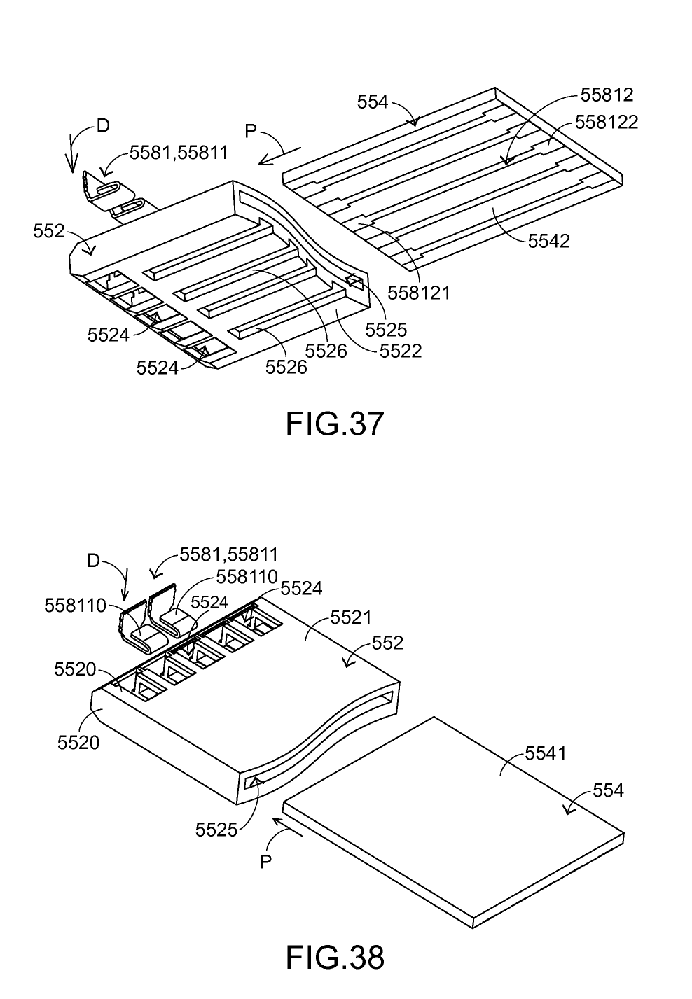

FIG. 36 is a schematic bottom view illustrating the circuit board of the electrical receptacle of the twentieth embodiment. FIG. 37 is a schematic exploded view illustrating the circuit board and the tongue plate of the electrical receptacle of the twentieth embodiment. FIG. 38 is a schematic exploded view illustrating the circuit board and the tongue plate of the electrical receptacle of the twentieth embodiment and taken along another viewpoint.

In this embodiment, the electrical receptacle 55 comprises a main body 551, a plastic tongue plate 552, a circuit board 554, a rear cover 555, and a metallic casing 559. The main body 551 has a docking space 5512. The plastic tongue plate 552 has a first surface 5521, a second surface 5522 and a plurality of contact holes 5524. These contact holes 5524 run through the first surface 5521 and the second surface 5522 of the plastic tongue plate 552. The plastic tongue plate 552 is fixed on a sidewall of a bottom part 5515 of the main body 551 and extended toward the front side. The circuit board 554 has a first surface 5541 and a second surface 5542.

Moreover, a receiving space for accommodating the circuit board 554 (i.e. the position of the circuit board 554) is located within the plastic tongue plate 452 and arranged between the first surface 5521 and the second surface 5522 of the plastic tongue plate 552.

In comparison with the above embodiments, a plurality of contact holes 5524 are located at the front end of the plastic tongue plate 552. These contact holes 5524 are in communication with the first surface 5521 and the second surface 5522 of the plastic tongue plate 552, the first surface 5541 and the second surface 5542 of the circuit board 554 and the receiving space 5525. Alternatively, in some embodiments (not shown), these contact holes 5524 only are in communication with one of the first surface 5521 and the second surface 5522 of the plastic tongue plate 552, or in communication with one of the first surface 5541 and the second surface 5542 of the circuit board 554.

Moreover, the plastic tongue plate 552 comprises a plurality of position-limiting recesses 5526. The position-limiting recesses 5526 do not run through the first surface 5521 and the second surface 5522 of the plastic tongue plate 552. These position-limiting recesses 5526 are formed in the first surface 5521 of the plastic tongue plate 552, and exposed to the docking space 5512. In addition, these position-limiting recesses 5526 are not in communication with the receiving space 5525.

In accordance with a key feature of the present invention, a single type of USB3.0 signal interface 558 is installed on the second surface 5522 of the plastic tongue plate 552 and arranged beside the docking space 5512. The USB3.0 signal interface 558 has five signal interface units 5581. Each of the signal interface units 5581 successively comprises three structure segments: (1) a contact segment 55811 (e.g. a metallic contact segment), (2) an extension wire 55812, and (3) a pin segment or a welding segment 55813 (e.g. a metallic pin segment or a welding segment). Moreover, the extension wires 55812 are installed on the surface of the circuit board 554, which is accommodated within the receiving space 5525. Moreover, a first conductive pad 558121 and a second conductive pad 558122 are disposed at a front end and a rear end of the extension wire 55812, respectively. Consequently, a bent part 558110 of the contact segment 55811 can be elastically sustained against the first conductive pad 558121, so that the contact segment 55811 is electrically connected with the first conductive pad 558121 and the second conductive pad 558122. In this embodiment, the pin segments 55813 (or the winding segments) are previously and fixedly welded on respective second conductive pads 558122. Moreover, the pin segments 55813 (or the winding segments) are accommodated within the rear cover 555.

Moreover, the USB3.0 signal interface 558 further comprises other four signal interface units 5582. Each of the signal interface units 5582 comprises three structure segments: (1) a contact resilience arm segment 55821 (e.g. a metallic contact resilience arm segment), (2) an extension segment 55822 (e.g. a metallic extension segment), and (3) a pin segment or a welding segment 55823 (e.g. a metallic pin segment or a welding segment). The three structure segments of the signal interface unit 5582 are integrally formed with each other. Moreover, the extension segments 55822 are fixed on the main body 551. Consequently, the extension segments 55822 are exposed to the docking space 5512 and sustained against the sidewalls of respective position-limiting recesses 5526.

In such way, except that the contact segments 55811 should be exposed to the docking space 5512, the other sections of the five signal interface units 5581 are separated from the four signal interface units 5582 by the plastic tongue plate 552. Consequently, the adverse influence of the crosstalk or electromagnetic interference on the interface signals during operations of any signal interface will be effectively reduced

Alternatively, the circuit board 554 and the plastic tongue plate 552 may be combined together or the contact segments 55811 and the plastic tongue plate 552 may be combined together in a simplified manner. Please refer to FIGS. 37 and 38. Firstly, the contact segments 55811 are accommodated within respective contact holes 5524 along the assembling direction D (see FIGS. 37 and 38). Then, the circuit board 554 is inserted into the receiving space 5525 from the rear end of the plastic tongue plate 552 along the assembling direction P (see FIGS. 37 and 38). Consequently, the bent parts 558110 of the contact segments 55811 are elastically sustained against respective first conductive pads 558121 of the circuit board 554.

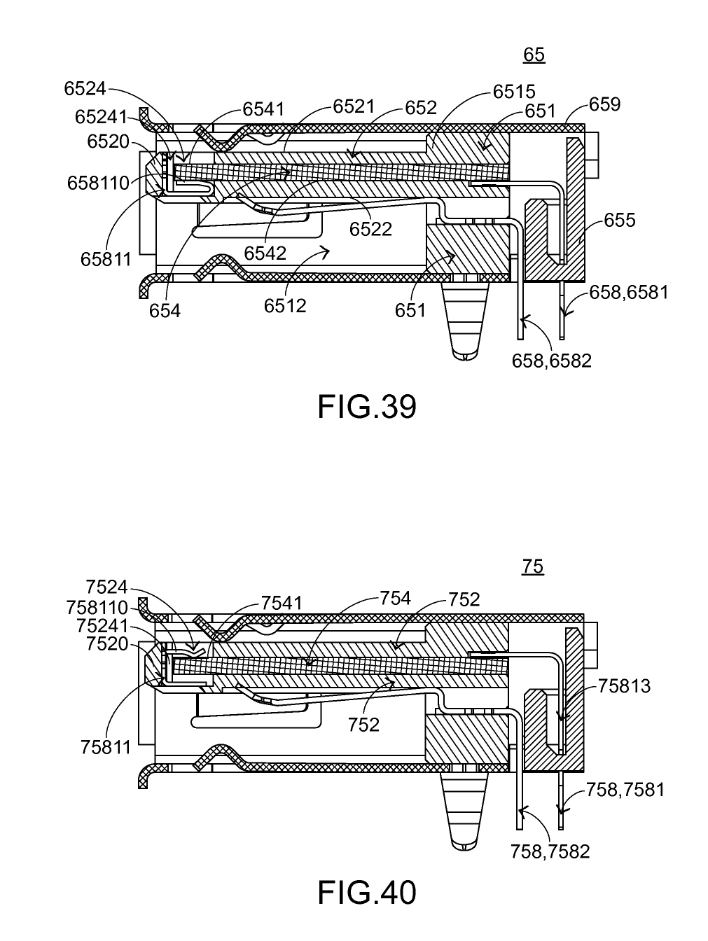

FIG. 39 is a schematic side view illustrating an electrical receptacle according to a twenty-first embodiment of the present invention. As shown in FIG. 39, the electrical receptacle 65 comprises a main body 651, a plastic tongue plate 652, a circuit board 654, a rear cover 655, and a metallic casing 659. The main body 651 has a docking space 6512. The tongue plate 652 has a first surface 6521, a second surface 6522 and a plurality of contact holes 6524. The plastic tongue plate 652 is fixed on a sidewall of a bottom part 6515 of the main body 651 and extended toward the front side. The circuit board 654 has a first surface 6541 and a second surface 6542.

Moreover, a single type of USB3.0 signal interface 658 is installed on the second surface 6522 of the plastic tongue plate 652 and arranged beside the docking space 6512. The USB3.0 signal interface 658 has five signal interface units 6581 and four signal interface units 6582.

In comparison with the twentieth embodiment, a vertical slab 65241 is accommodated within each of the contact holes 6524 of the electrical receptacle 65 of this embodiment. Moreover, there is a gap between the vertical slab 65241 and the front end 6520 of the plastic tongue plate 652, so that the contact segment 65811 of a corresponding signal interface units 6581 can be securely fixed within the corresponding contact hole 6524. In such way, the bent part 658110 of the contact segment 65811 can be elastically sustained against the extension wire (not shown) that is disposed on the second surface 6542 of the circuit board 654.

FIG. 40 is a schematic side view illustrating an electrical receptacle according to a twenty-second embodiment of the present invention. The electrical receptacle 75 of this embodiment has a single type of USB3.0 signal interface 758. The USB3.0 signal interface 758 has five signal interface units 7581 and four signal interface units 7582. Except for the following items, the other components and mechanisms of the electrical receptacle of this embodiment are similar to those of the twenty-first embodiment, and are not redundantly described herein.

Moreover, there is a gap between the vertical slab 75241 and the front end 7520 of the plastic tongue plate 752, so that the contact segment 75811 of a corresponding signal interface unit 7581 can be securely fixed within the corresponding contact hole 7524.

In comparison with the twenty-first embodiment, the bent part 758110 of the contact segment 75811 can be elastically sustained against the extension wire (not shown) that is disposed on the first surface 7541 of the circuit board 754.

Moreover, the pin segments 75813 (or the winding segments) of the signal interface units 7581 are previously and fixedly welded on the first surface 7541 of the circuit board 754. Consequently, the extension wires (not shown) on the first surface 7541 of the circuit board 754 and the pin segments 75813 (or the winding segments) are electrically connected with each other.

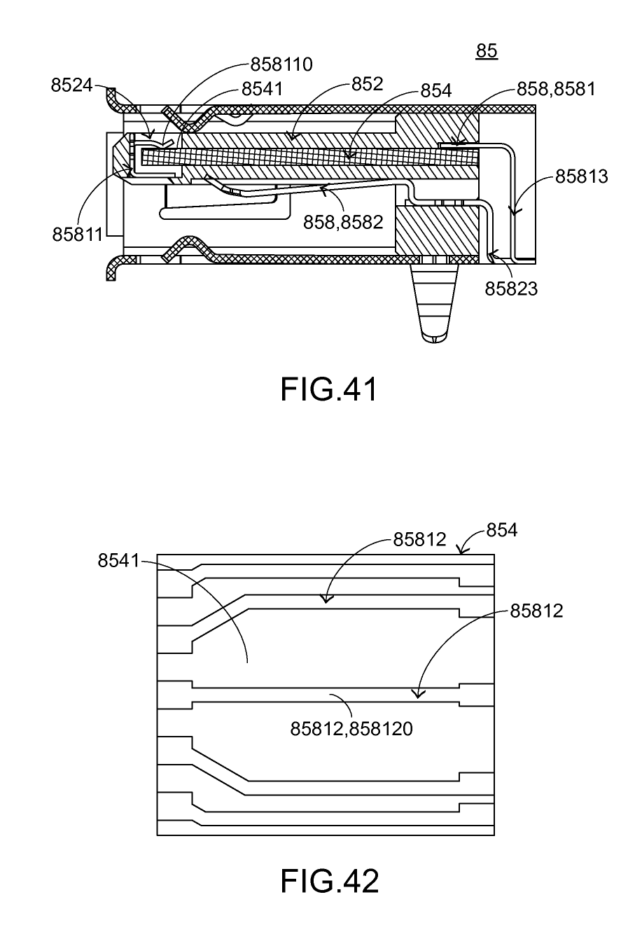

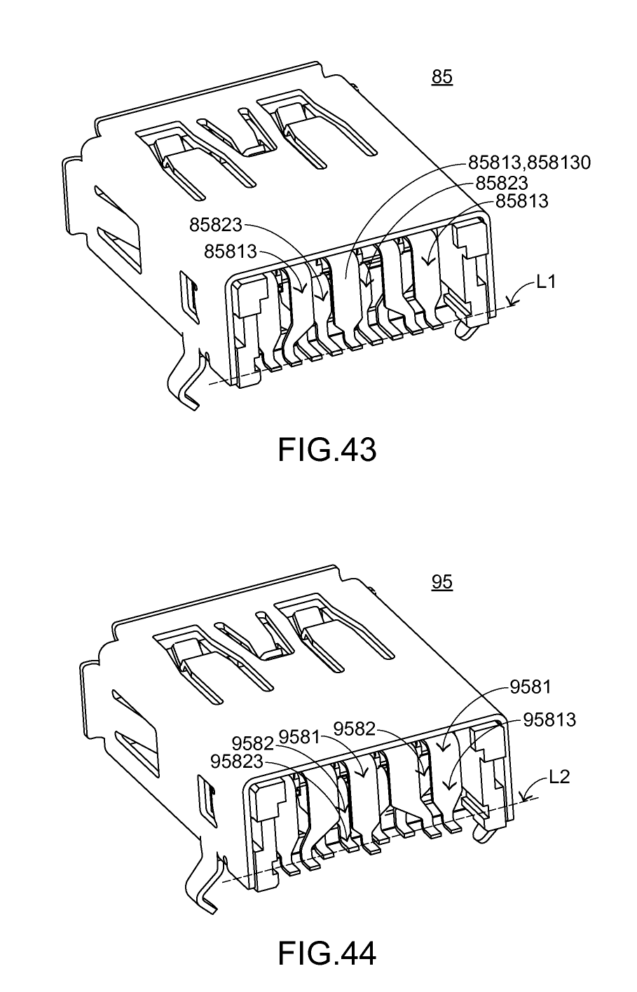

FIG. 41 is a schematic side view illustrating an electrical receptacle according to a twenty-third embodiment of the present invention. FIG. 42 is a schematic top view illustrating the circuit board of the electrical receptacle of the twenty-third embodiment. FIG. 43 is a schematic three-dimensional rear view illustrating the electrical receptacle of the twenty-third embodiment. The electrical receptacle 85 of this embodiment has a single type of USB3.0 signal interface 858. The USB3.0 signal interface 858 has five signal interface units 8581 and four signal interface units 8582. Except for the following items, the other components and mechanisms of the electrical receptacle of this embodiment are similar to those of the twenty-second embodiment, and are not redundantly described herein.

In comparison with the twenty-second embodiment, no vertical slab is accommodated within the contact hole 8524 of the plastic tongue plate 852. In addition, the electrical receptacle 85 has no rear cover. The distal ends of the pin segments (or welding segments) 85813 of the five signal interface units s 8581 and distal ends of the pin segments (or welding segments) 85823 of the four signal interface units 8582 are parallel with and separated from each other and located at the same horizontal line L1. Moreover, the bent parts 858110 of the contact segments 85811 of the five signal interface units 8581 are elastically sustained against respective extension wires 85812 that are disposed on the first surface 8541 of the circuit board 854.

Moreover, five extension wires 85812 are disposed on the first surface 8541 of the circuit board 854. One of these five extension wires 85812 is a ground extension wire 858120 connected to the ground for transmitting a ground signal, and preferably located near the middle position of the electrical receptacle 85 (or the circuit board 854). The other four of these five extension wires 85812 are arranged beside the ground extension wire 858120 for transmitting data signals. In this embodiment, two extension wires 85812 are located at one of bilateral sides of the ground extension wire 858120. Consequently, the adverse influence of the crosstalk or electromagnetic interference on the signals during operations of any signal interface will be effectively reduced.

Similarly, one of the pin segments (or welding segments) 85813 of the five signal interface units 8581 is a ground pin segment (or a ground welding segment) 858130 to be connected to the ground, and preferably located near the middle position of the electrical receptacle 85 (or the circuit board 854). The other four of these five pin segments (or welding segments) 85813 are arranged beside the ground pin segment (or a ground welding segment) 858130. In this embodiment, two pin segments (or welding segments) 85813 are located at one of bilateral sides of the ground pin segment (or the ground welding segment) 858130.

For further reducing the adverse influence of the crosstalk or electromagnetic interference, the pin segments (or welding segments) 85823 of the four signal interface units 8582 are closer to the ground pin segment (or the ground welding segment) 858130 than the four pin segments (or welding segments) 85813 of the five signal interface units 8581 for transmitting signals.

Preferably, if two of the four signal interface units 8582 for transmitting a data signal group (rather than the power signal and the ground signal) are located near the middle position of the electrical receptacle 85, the adverse influence of the crosstalk or electromagnetic interference will be further reduced.

That is, if the signal interface units for transmitting the signal group are closely or centralized arranged, the adverse influence of the crosstalk or electromagnetic interference will be further reduced.

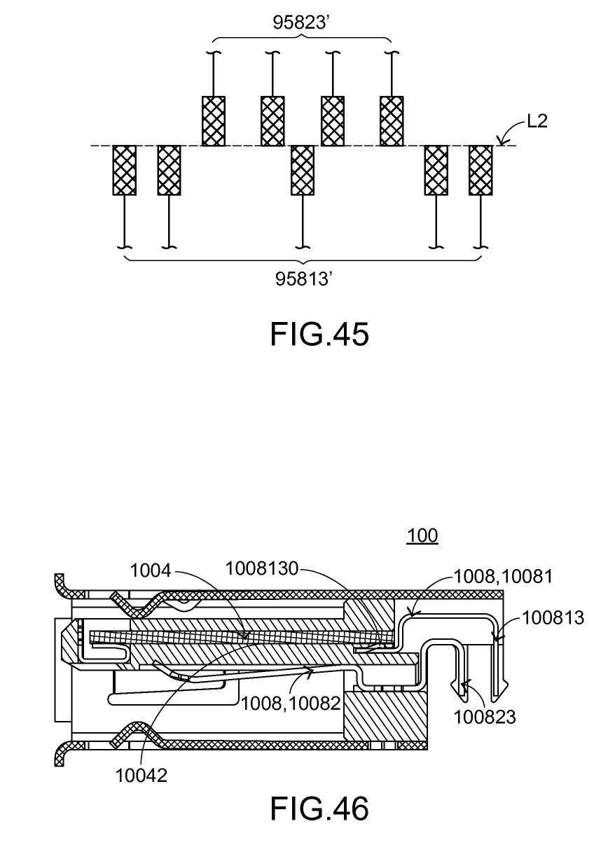

FIG. 44 is a schematic three-dimensional rear view illustrating an electrical receptacle according to a twenty-fourth embodiment of the embodiment. FIG. 45 schematically illustrates arrangement of the insertion holes of a system board corresponding to the pin segments (or welding segments) of the electrical receptacle of the twenty-fourth embodiment. The electrical receptacle 95 of this embodiment has a single type of USB3.0 signal interface 958. The USB3.0 signal interface 958 has five signal interface units 9581 and four signal interface units 9582. Except for the following items, the other components and mechanisms of the electrical receptacle of this embodiment are similar to those of the twenty-third embodiment, and are not redundantly described herein.

In the electrical receptacle 955 of this embodiment, the distal ends of the five pin segments (or welding segments) 95813 of the five signal interface units 9581 and the distal ends of the pin segments (or welding segments) 95823 of the four signal interface units 9582 are separated from each other, arranged in a staggered form, and located at bilateral sides of a horizontal line L2. In such way, the insertion holes 95813′ and 985823′ of the system board corresponding to the pin segments (or welding segments) 95813 and 985823 are separated from each other, arranged in a staggered form, and located at bilateral sides of the horizontal line L2.

FIG. 46 is a schematic side view illustrating an electrical receptacle according to a twenty-fifth embodiment of the embodiment. The electrical receptacle 100 of this embodiment has a single type of USB3.0 signal interface 1008. The USB3.0 signal interface 1008 has five signal interface units 10081 and four signal interface units 10082. Except for the following items, the other components and mechanisms of the electrical receptacle of this embodiment are similar to those of the twentieth embodiment, and are not redundantly described herein.

In comparison with the twentieth embodiment, the electrical receptacle 100 of this embodiment has no rear cover. Moreover, the distal sections of the five pin segments (or welding segments) 100813 of the five signal interface units 10081 and the distal sections of the pin segments (or welding segments) 100823 of the four signal interface units 10082 are relatively shorter. Consequently, after the electrical receptacle 100 is mounted on the system board (not shown), the overall height is reduced. That is, the electrical receptacle is mounted on the system board in a sink-plate mounting manner.

Moreover, the pin segment 100813 (or the welding segment) has a bent part 1008130. The bent part 1008130 is sustained against the extension wire (not shown) that is previously installed on the second surface 10042 of the circuit board 1004. Consequently, the extension wire and the pin segment (or the welding segment) 100813 are electrically connected with each other.

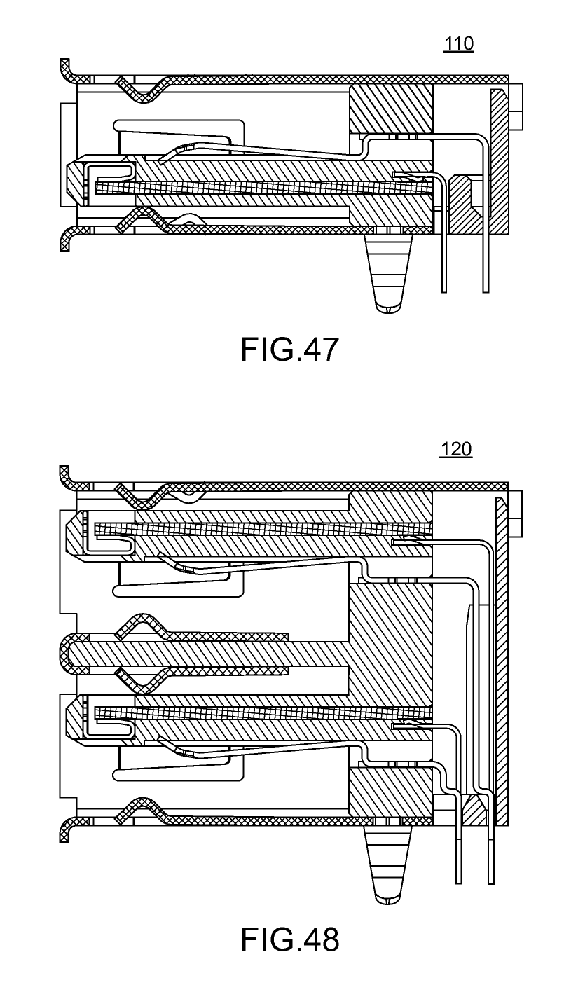

FIG. 47 is a schematic side view illustrating an electrical receptacle according to a twenty-sixth embodiment of the embodiment. FIG. 48 is a schematic side view illustrating an electrical receptacle according to a twenty-seventh embodiment of the embodiment. Except for the following items, the other components and mechanisms of the electrical receptacles 110 and 120 are similar to those of the twentieth embodiment, and are not redundantly described herein. For example, the electrical receptacle 110 is a reverse docking design and is not assembled in the sink-plate mounting manner. Whereas, the electrical receptacle 120 is a stack-type design and comprises at least two stacked electrical receptacle units.

From the above description, the electrical receptacle of the present invention is industrially valuable because of the following benefits.

Firstly, the electrical receptacle has a shared docking recess for accommodating various signal interfaces.

Secondly, since the tongue plate and the circuit board are stacked on each other to provide a composite tongue plate structure for carrying the signal interfaces, the composite tongue plate structure is helpful for integrating more different signal interfaces into a single electrical receptacle. By means of the composite tongue plate structure, the contact resilience arms of the USB2.0/USB3.0 signal interface can be led to different docking spaces. Consequently, the adverse influence of the crosstalk or electromagnetic interference on the interface signals during operations of any signal interface will be effectively reduced.

Thirdly, for complying with various size specifications of the electronic products or the handheld devices, the thickness of the circuit board may be changed while the thickness of tongue plate is kept changed. Consequently, the fabricating and operating cost will be effectively reduced.

Fourthly, the novel receptacle structures provided in the above embodiments of the present invention are effective to ease the assembling process and reduce the operating cost. Consequently, the concepts of the present invention can be applied to the electrical receptacle with various signal interfaces. That is, the applications of the electrical receptacle are largely expanded.

Fifthly, since some of signal interface structure segments are installed on the circuit board and separated from the other signal interface structure segments to be used as a signal transmission medium, the adverse influence of the crosstalk or electromagnetic interference on the interface signals during operations of various high-speed data transmission signal interfaces or high-speed image transmission signal interfaces will be minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electrical receptacle having at least one docking space for accommodating an electrical plug, said electrical receptacle comprising:
a plastic main body;
a tongue plate having a first tongue plate surface and a second tongue plate surface; and
a circuit board accommodated within a receiving space of said tongue plate, and having a first circuit board surface and a second circuit board surface, wherein a first signal interface is installed on said circuit board.

2. The electrical receptacle according to claim 1 further comprising a rear cover, wherein said rear cover comprises a plurality of fixing recesses with position-limiting structures for previously accommodating and fixing at least a portion of extension segments or fixture segments of an additional signal interface, or
wherein said rear cover has a plurality of receiving holes for accommodating at least a portion of pin segments of said first signal interface and said additional signal interface, or
wherein said rear cover comprises a plurality of fixing recesses for previously accommodating and fixing at least a portion of extension segments or fixture segments of said additional signal interface, and a plurality of receiving holes for accommodating at least a portion of pin segments of said first signal interface and said additional signal interface.

3. The electrical receptacle according to claim 2 further comprising a pressing plate or a pressing structure, which is either an individual component or a part of said rear cover.

4. The electrical receptacle according to 1 further comprising a second signal interface and/or a third signal interface, wherein at least one of said second signal interface and said third signal interface is installed on said plastic main body, or installed on said circuit board, or installed in a second docking space beside said circuit board, or installed on said tongue plate, or installed in a first docking space beside said tongue plate, or installed in a region between said tongue plate and said circuit board, or installed on said rear cover, or installed in said at least one docking space including at least one of said first docking space and said second docking space.

5. The electrical receptacle according to claim 4 wherein no signal interface is installed on said plastic main body, or said plastic main body has two lateral walls extended toward a front side thereof, or said plastic main body is not integrally formed with said tongue plate, wherein a shared profile mating with various signal interfaces of said electrical plug is defined by front peripheries of said two lateral walls.

6. The electrical receptacle according to claim 4 wherein said tongue plate is a plastic tongue plate fixed on a sidewall of a bottom part of said plastic main body and extended toward a front side thereof, or said tongue plate is a removable plastic tongue plate assembled with said plastic main body, wherein said circuit board is a removable circuit board.

7. The electrical receptacle according to claim 6 wherein said plastic tongue plate and said plastic main body are combined together in an up/down stacking manner.

8. The electrical receptacle according to claim 6 wherein said plastic tongue plate is an individual component, or said plastic tongue plate and said rear cover are integrally formed.

9. The electrical receptacle according to claim 6 wherein said plastic tongue plate has a plurality of slots running through said first tongue plate surface and said second tongue plate surface, and said circuit board has a plurality of grooves running through said first circuit board surface and said second circuit board surface, wherein said slots of said plastic tongue plate and said grooves of said circuit board are aligned with each other, so that said first docking space and said second docking space are in communication with each other.

10. The electrical receptacle according to claim 9 wherein said second signal interface has a plurality of contact resilience arm segments penetrated through said slots of said plastic tongue plate and said grooves of said circuit board, so that said contact resilience arm segments are accommodated within said first docking space, wherein said second signal interface has a plurality of extension segments or extension wires and a plurality of pin segments, which are accommodated within said second docking space.

11. The electrical receptacle according to claim 6 further comprising a beveled edge structure, which is located at a front end of said plastic tongue plate and a front end of said circuit board for facilitating said electrical plug to be accommodated within at least one of said first docking space and said second docking space, wherein said beveled edge structure is coupled with said front end of said plastic tongue plate, and said beveled edge structure has a vertical bulge for blocking said front end and a part of a lateral edge of said circuit board, or said vertical bulge of said beveled edge structure is integrally extended from said front end of said plastic tongue plate for blocking said front end and said part of said lateral edge of said circuit board.

12. The electrical receptacle according to claim 6 wherein said first signal interface is an eSATA signal interface, said second signal interface is a USB 2.0 signal interface, and said third signal interface and said USB 2.0 signal interface are collaboratively defined as a USB3.0 signal interface, wherein each signal interface unit of said first signal interface, said second signal interface and said third signal interface is composed of four structure segments: (1) a contact pad or a contact resilience arm segment or a contact segment, (2) an extension wire or an extension segment, (3) a fixture segment, and (4) a pin segment or a welding segment, or each signal interface unit of said first signal interface, said second signal interface and said third signal interface is composed of three structure segments: (1) a contact pad or a contact resilience arm segment or a contact segment, (2) an extension wire or an extension segment, and (3) a pin segment or a welding segment, or each signal interface unit of said first signal interface, said second signal interface and said third signal interface is composed of two structure segments: (1) a contact and extension segment or a contact and extension wire, and (2) a pin segment or a welding segment.

13. The electrical receptacle according to claim 6 wherein said first docking space is a lateral space beside said first tongue plate surface and excluding said first tongue plate surface, and said second docking space is another lateral space beside said second circuit board surface and excluding said second circuit board surface.

14. The electrical receptacle according to claim 1 wherein said receiving space is arranged beside said second tongue plate surface for accommodating said circuit board, wherein said first circuit board surface is arranged beside said second tongue plate surface.

15. The electrical receptacle according to claim 14 wherein said receiving space is defined by said second tongue plate surface and a vertical bulge of said tongue plate, or said receiving space is defined by said second tongue plate surface, a bottom part of said plastic main body or a sidewall of said rear cover, and said vertical bulge, wherein when said circuit board is accommodated within said receiving space, an altitude of said second circuit board surface is identical to or different from an altitude of a surface of said vertical bulge.

16. The electrical receptacle according to claim 1 wherein said receiving space is located within said tongue plate and arranged between said first tongue plate surface and said second tongue plate surface for accommodating said circuit board.

17. The electrical receptacle according to claim 1 further comprising a metallic casing, wherein said metallic casing is sheathed around said plastic main body, or said metallic casing is sheathed around an outer periphery of a combination of said plastic main body and a rear cover.

18. An electrical receptacle having at least one docking space for accommodating an electrical plug, said electrical receptacle comprising:
a first plastic main body;
a plastic tongue plate installed on said first plastic main body, and having a first tongue plate surface and a second tongue plate surface;
a circuit board accommodated within a receiving space of said tongue plate, and having a first circuit board surface and a second circuit board surface;
a second plastic main body combined with or integrally with at least one of said first plastic main body and said plastic tongue plate; and
a plurality of signal interfaces, wherein at least one signal interface is installed on said circuit board, and the other ones of said signal interfaces are installed on at least one of said first plastic main body, said plastic tongue plate and said second plastic main body.

19. An electrical receptacle having at least one docking space for accommodating an electrical plug, said electrical receptacle comprising:
a plurality of signal interfaces; and
a composite tongue plate structure to be coupled with said electrical plug, wherein at least one of a top surface and a bottom surface of said composite tongue plate structure is arranged beside said at least one docking space including at least one of said first docking space and a second docking space, and said composite tongue plate structure is composed of a plastic tongue plate and a circuit board.

20. The electrical receptacle according to claim 19 wherein said plurality of signal interfaces include a USB2.0 or USB3.0 signal interface and an eSATA signal interface, which are collaboratively defined as an all-in-one signal interface, or said plurality of signal interfaces include two USB2.0 signal interfaces or two USB3.0 signal interfaces, or said plurality of signal interfaces are collaboratively defined as a high-speed transmission signal interface including a single-type eSATA signal interface or a single-type USB3.0 signal interface, wherein each signal interface unit of said signal interfaces is composed of four structure segments: (1) a contact pad or a contact resilience arm segment or a contact segment, (2) an extension wire or an extension segment, (3) a fixture segment, and (4) a pin segment or a welding segment, or each signal interface unit of said signal interfaces is composed of three structure segments: (1) a contact pad or a contact resilience arm segment or a contact segment, (2) an extension wire or an extension segment, and (3) a pin segment or a welding segment, or each signal interface unit of said signal interfaces is composed of two structure segments: (1) a contact and extension segment or a contact and extension wire, and (2) a pin segment or a welding segment.

21. An electrical receptacle having at least one docking space for accommodating an electrical plug, said electrical receptacle comprising:
a plurality of signal interfaces; and
a composite tongue plate structure to be coupled with said electrical plug, wherein a metallic contact part of at least one signal interface is installed on each of a top surface and a bottom surface of said composite tongue plate structure, and said composite tongue plate structure is composed of a plastic tongue plate and a circuit board.

22. The electrical receptacle according to claim 21 wherein said plurality of signal interfaces include a USB2.0 or USB3.0 signal interface and an eSATA signal interface, which are collaboratively defined as an all-in-one signal interface, or said plurality of signal interfaces include two USB2.0 signal interfaces or two USB3.0 signal interfaces, or said plurality of signal interfaces are collaboratively defined as a high-speed transmission signal interface including a single-type eSATA signal interface or a single-type USB3.0 signal interface, wherein each signal interface unit of said signal interfaces is composed of four structure segments: (1) a contact pad or a contact resilience arm segment or a contact segment, (2) an extension wire or an extension segment, (3) a fixture segment, and (4) a pin segment or a welding segment, or each signal interface unit of said signal interfaces is composed of three structure segments: (1) a contact pad or a contact resilience arm segment or a contact segment, (2) an extension wire or an extension segment, and (3) a pin segment or a welding segment, or each signal interface unit of said signal interfaces is composed of two structure segments: (1) a contact and extension segment or a contact and extension wire, and (2) a pin segment or a welding segment.

23. An electrical receptacle having at least one docking space for accommodating an electrical plug, said electrical receptacle comprising:
a first plastic main body;
a plastic tongue plate installed on said first plastic main body, and having a first tongue plate surface and a second tongue plate surface;
a circuit board accommodated within a receiving space of said tongue plate, and having a first circuit board surface and a second circuit board surface;
a plurality of signal interface structure segments, wherein at least a portion of said signal interface structure segments are installed on said circuit board, and the other ones of said signal interface structure segments are installed on at least one of said first plastic main body and said plastic tongue plate.

24. The electrical receptacle according to claim 23 wherein said plurality of signal interface structure segments include USB2.0 or USB3.0 signal interface structure segments and eSATA signal interface structure segments to be collaboratively defined as an all-in-one signal interface, or said plurality of signal interface structure segments include two groups of USB2.0 signal interface structure segments or two groups of USB3.0 signal interface structure segments to be collectively defined as two USB2.0 signal interfaces or two USB3.0 signal interfaces, or said plurality of signal interface structure segments are high-speed transmission signal interface structure segments including single-type eSATA signal interface structure segments or single-type USB3.0 signal interface structure segments to be collaboratively defined as a high-speed transmission signal interface including a single-type eSATA signal interface or a single-type USB3.0 signal interface, wherein said signal interface structure segments are classified into four types: (1) a contact pad or a contact resilience arm segment or a contact segment, (2) an extension wire or an extension segment, (3) a fixture segment, and (4) a pin segment or a welding segment, or said signal interface structure segments are classified into three types: (1) a contact pad or a contact resilience arm segment or a contact segment, (2) an extension wire or an extension segment, and (3) a pin segment or a welding segment, or said signal interface structure segments are classified into two types: (1) a contact and extension segment or a contact and extension wire, and (2) a pin segment or a welding segment.

25. The electrical receptacle according to claim 24 wherein said receiving space is disposed within said plastic tongue plate and arranged between said first tongue plate surface and said second tongue plate surface for accommodating said circuit board, wherein a plurality of contact holes are located at a front end of at least one of said first tongue plate surface and said second tongue plate surface for at least partially accommodating said contact segments or said contact and extension segments, wherein said contact holes are in communication with said receiving space and at least one of said first circuit board surface and said second circuit board surface.

26. The electrical receptacle according to claim 24 wherein said at least a portion of said signal interface structure segments installed on said circuit board are elastically sustained against or fixedly welded on another portion of said signal interface structure segments so as to be electrically connected with each other.

27. The electrical receptacle according to claim 26 wherein said USB3.0 signal interface has five first signal interface units with said contact segments, and said each of said five first signal interface units successively comprises three structure segments: (1) said contact segment, (2) said extension wire, and (3) said pin segment or said welding segment, or each signal interface unit of said eSATA signal interface successively comprises three structure segments: (1) said contact pad, (2) said extension wire, and (3) said pin segment or said welding segment, wherein said extension wire is formed on said circuit board, and a first conductive pad and a second conductive pad are respectively disposed at a front end and a rear end of said extension wire, so that said contact segment is elastically sustained against or fixedly welded on said first conductive pad and/or said pin segment or said welding segment is elastically sustained against or fixedly welded on said second conductive pad.

28. The electrical receptacle according to claim 27 wherein said USB3.0 signal interface further has four second signal interface units with said contact resilience arm segments, and said pin segments or said welding segments of said five first signal interface units and said pin segments or said welding segments of said four second signal interface units are arranged in parallel with each other or arranged in a staggered form, wherein said pin segments or welding segments of two of said four second signal interface units are located near a middle position of said electrical receptacle for transmitting a first signal group, and said pin segments or said welding segments of the other two of said four second signal interface units are arranged at bilateral sides of said pin segments or said welding segments of said two signal interface units which transmit said first signal group, or
wherein said extension wire or said welding segment or said welding segment of one of said five first signal interface units is arranged near said middle position of said electrical receptacle to be used as a ground signal interface unit for transmitting a ground signal, and said extension wires or said welding segments or said welding segments of two of the other four first signal interface units are arranged at each of bilateral sides of said ground signal interface unit for transmitting a second signal group, or
wherein said pin segments or said welding segments of said two second signal interface units for transmitting said first signal group are closer to said pin segment or said welding segment of said ground signal interface unit than said pin segments or said welding segments of said four second signal interface units for transmitting said second signal group.

29. The electrical receptacle according to claim 24 wherein said plastic tongue plate comprises a plurality of position-limiting recesses not running through said first tongue plate surface and said second tongue plate surface, wherein said contact resilience arm segments exposed to said at least one docking space are sustained against corresponding position-limiting recesses, wherein said position-limiting recesses are formed in one of said first tongue plate surface and said second tongue plate surface and exposed to said at least one docking space, but are not in communication with said receiving space.

30. The electrical receptacle according to claim 23 wherein said plastic tongue plate has a plurality of slots running through said first tongue plate surface and said second tongue plate surface, wherein corresponding contact resilience arm segments are penetrated through said slots of said plastic tongue plate and exposed to said at least one docking space.

31. The electrical receptacle according to claim 23 further comprising a second plastic main body, wherein said second plastic main body is combined with or integrally formed with at least one of said first plastic main body and said plastic tongue plate, wherein said other ones of said signal interface structure segments are installed on at least one of said first plastic main body, said second plastic main body and said plastic tongue plate.
